(19) United States
(12) Patent Application Publication
(10) Pub. No.: US 2022/0206470 A1
(43) Pub. Date: Jun. 30, 2022

(54) SYSTEMS AND METHODS FOR UNIVERSAL SEQUENCING LOGIC CONFIGURATIONS IN INDUSTRIAL AUTOMATION

(71) Applicant: Chad Wallace, Charlottesville, IN (US)

(72) Inventor: Chad Wallace, Charlottesville, IN (US)

(21) Appl. No.: 17/207,650

(22) Filed: Mar. 20, 2021

Related U.S. Application Data
(60) Provisional application No. 63/132,717, filed on Dec. 31, 2020.

(51) Int. Cl. G05B 19/418; G06F 16/958

(52) U.S. Cl. CPC G05B 19/4185; G06F 16/986; G05B 19/41865; G05B 19/4183

(57) ABSTRACT

Sequencing systems and methods are provided for use with industrial automation processes that enable the translation of signals from a plurality of controllers in communication therewith, such as programmable logic controllers, into a single file format that can be universally understood throughout the other components of the system. Such systems allow for the display of run-time data in real time. The systems hereof are also configured to translate configurations understood by a control system (e.g., a SCADA system) into disparate controller protocols, which allows for the remote reconfiguration and adjustment of equipment at both hardware and software levels from a centralized location. Methods for facilitating a centralized control of an industrial automation process are also provided.

### PRIORITY

The present U.S. nonprovisional patent application relates to and claims the priority benefit of U.S. Provisional Patent Application Ser. No. 63/132,717 to Wallace, filed Dec. 31, 2020, the content of which is hereby incorporated herein by reference in its entirety.

### BACKGROUND

Industrial process control and automation systems are often used to automate large and complex industrial processes. These types of systems routinely include sensors, actuators, and controllers (each and input/output (I/O), with some for receiving measurements from the sensors and generating control signals for the actuators and others performing higher-level functions, such as planning, scheduling, and optimizing operations.

While various advancements have been made over the years to these systems in general, utilization and design of programmable logic controllers (PLCs) in particular has been largely unchanged. A PLC is a special-purpose microcomputer that can be programmed to control one or more physical devices (for example, and without limitation, factory machines, sensors, and end devices). In conventional systems, PLCs receive information from the one or more physical devices and route the information received to a computer with a supervisory control and data acquisition (SCADA) system software or the like. PLCs can range from small modular devices with tens of I/O in a housing integral with the processor, to large rack-mounted, modular systems with thousands of I/O.

A common problem associated with control systems is lack of uniformity across system/process boundaries, as well as a lack of uniformity between PLC manufacturers, software vendors, and customers. This can be as simplistic as discrepancies in naming conventions between a software vendor and a customer, or as complex as disparate software representations with respect to portions of an industrial automation framework. A substantial amount of ad-hoc coding is often required to automate a process to ensure the various pieces can adequately communicate (e.g., each PLC with the SCADA system). Accordingly, a manufacturer must employ computer and programming specialists to generate and maintain these ad-hoc programs, which results in significant cost that is ultimately passed along to the consumer.

For example, there are a large number of PLCs on the market today that allow the ladder logic program to be written on an external computer and then downloaded to the PLC via a communications port. A complete ladder logic program is referred to as a control application and can consist of hundreds or thousands of lines of code because each detail of the program action must be explicitly manipulated by the programmer in the program code. As currently implemented, ladder logic software requires the programmer to individually include each analog setpoint and each individual discrete input into the ladder logic diagram. If class logic is required, the programmer must write this functionality specifically into the program. Sensor failure logic must also be programmed into the controller program, as well as a method of checking sensor operation while the equipment is running (test mode). In addition to requiring a large amount of code to be written to execute the controller program, any change in the parameters governing the PLC inputs (i.e. at the SCADA level) involves manually updating the controller program itself at the PLC level.

Additionally, with conventional systems, it is not only difficult to locate, sort, package, and map data associated with a PLC and/or a particular I/O device, but this problem is compounded if several applications need to utilize similar data. In operation, various controllers output data, package it in a flat namespace structure, and provide it to a network. Each application utilizing the data copies such data into its internal memory, sorts the data, organizes the data, and packages the data in a desired format. Accordingly, multiple copies of similar data exist in a plurality of locations, where each copy of the data may be organized and packaged disparately.

PLCs are often networked to other controllers and a human machine interface (HMI)—which may be a SCADA system or otherwise—to form an environment where a majority of modem and automated manufacturing operations occur. The HMI/SCADA software provides a centralized control system architecture and is responsible for monitoring, managing, and controlling the operation of the automated system. However, SCADA systems cannot intrinsically alter the logic of a PLC executing a user program; instead, they merely allow for simple setpoint changes that require additional support in the form of deliberate changes made at the local PLC level (and independently for each PLC affected that has a different programming structure). Furthermore, SCADA systems cannot provide real time logic troubleshooting.

The basic architecture of a conventional SCADA system is made up of PLCs, discrete proportional-integral-derivative (PID) controllers, and/or a remote terminal unit (RTU), each of which are in communication with one or more I/O. The SCADA software communicates with the various PLCs and/or RTUs, typically over a data network such as, for example, the Internet or a Local Area Network. This can assist operators in analyzing the data and making important decisions. By polling each piece of equipment and requesting the contents of the desired registers, the SCADA software can display certain status of an entire system.

Often, SCADA will also have a separate HMI component accessible via a workstation to allow a human operator to interact with the system for high-level process supervisory management. The HMI enables monitoring and the issuing of process commands; however, subordinated operations (for example the real-time control logic or controller calculations) are performed by networked modules that connect to the field PLCs and PID controllers that interface to the process plant or machinery. While a process or control engineer can use the HMI, which may include a graphical interface, to modify the setpoints (controlled values) of one or more PLCs of the system or even shutdown the system entirely, in conventional systems logic changes (e.g., to switch the system to manufacture a new product pursuant to new steps) must be made at the PLC level, which remains a tedious process.

Accordingly, what is needed is a flexible industrial automation system that simplifies implementation, support and maintenance. Additionally, there is a significant need for systems that allow for centralized adjustment of parameters across an array of PLCs to efficiently implement overall process changes and modifications (e.g., modification of batch size).

### BRIEF SUMMARY

The systems and methods hereof provide for flexible automation processes that are accurate, reliable and easily scalable. In at least one exemplary embodiment, such processes are driven via a novel sequencing system configured to act as a middleware platform or module between one or more output devices or a system (e.g., a supervisory control and data acquisition (SCADA) and/or human machine interface (HMI) or similar system employed) and each individual controller (e.g., a programmable logic controller (PLC)) in the system, thus reducing the need for discrete complex programming sequences specific to any one PLC, RTU, PIDs, or an input/output (I/O) device. The systems and methods hereof allow for cross-platform interoperability, high security, and reliability.

In certain embodiments, such a sequencing system comprises one or more servers, at least one database having a set schema in communication with the one or more servers, and one or more software applications executable by the one or more servers. In at least one embodiment, the one or more software applications comprise at least a file service and a data service. The file service can be in communication with the at least one database and configured to populate an active file set based on data from a selected configuration stored in the at least one database. In at least one embodiment, the data service comprises a set of drivers, each driver configured to: bidirectionally communicate with a set of one or more controllers that have a protocol, translate feedback data received from the set of controllers into a uniform format that correlates with and is storable within the at least one database; and translate data from the active file set into the protocol. The selected configuration can comprise, for example, a series of instructions and parameters for executing an industrial automation system program using one or more controllers.

The sequencing system can further comprise a plurality of controllers. Each controller can be in communication at least one input/output (I/O) device and the server, the database, or both over a network. The one or more controllers can be, for example, selected from a group consisting of a programmable logic controller, a remote terminal unit, and a proportional-integral-derivative controller. In at least one embodiment, each controller comprises a protocol, wherein there are at least two different protocols within the plurality of controllers. In certain embodiments, each protocol can comprise disparate high level command structures.

The sequencing systems hereof can further comprise an output device or system in communication with the at least one database. In certain embodiments, the at least one database further comprises: at least one table, each table populated with a series of steps for an automation program to be performed by the I/O devices in communication with the plurality of controllers, and each step comprising one or more setpoint values for each I/O device at each step; and at least one folder dedicated to each of the plurality of controllers, each folder comprising mapping data of the respective controller and each I/O device in communication therewith and fields for inputting the one or more setpoint values from the at least one table.

In at least one exemplary embodiment, the output device or system is configured to read the uniform format. A non-limiting example of such an output device or system comprises an HMI. In at least one embodiment, the HMI can be part of a SCADA system. In at least one embodiment, the output device or system comprises a reporting module. The reporting module can, for example, be configured to generate a report based, at least in part, on the feedback data stored in the at least one database.

In certain embodiments, the one or more software applications can additionally comprise a configuration application configured to receive and store, in the at least one database, one or more configurations. For example, each configuration can comprise a series of sequences to be performed by a set of one or more controllers associated input/output devices, with each sequence associated with one or more setpoints, conditions, or values.

In certain embodiments, the uniform format can be selected from a group consisting of an XML format, a SCV format, a JSON format, a MDF format, a NDF format, and an LDF format.

The systems hereof can also comprise a data service configured to transmit feedback data translated into the uniform format to the at least one database.

Sequencing systems comprising SCADA systems are also provided. In at least one embodiment, a sequencing system hereof comprises one or more servers; at least one database having a set schema in communication with the one or more servers; one or more software applications executable by the one or more servers; a SCADA system in communication with at least the first database of the at least one database; and a reporting module in communication with the at least one database and the SCADA system, the reporting module configured to generate a report based, at least in part, on the feedback data stored in the at least one database. The one or more software applications comprise at least a file service and a data service. The SCADA system can, for example, be in communication with a second database of the at least one database, wherein the selected configuration is saved in the second database.

The file service can be in communication with the at least one database and configured to populate an active file set based on data from a selected configuration. The data service can comprise a set of drivers, each driver configured to: bidirectionally communicate with a set of one or more controllers that have a protocol, translate feedback data received from the set of controllers into a uniform format that correlates with and is storable within the at least one database, transmit the translated feedback data to a first database of the at least one database, and translate data from the active file set into the protocol. The selected configuration, in at least one embodiment, comprises a series of instructions and parameters for executing an industrial automation system program using one or more controller.

Methods for changing between active configurations in an industrial automation system are also provided. In at least one embodiment, the method comprises: providing a sequencing system as described in any of the embodiments set forth herein; executing a first configuration of one or more configurations (e.g., stored in the at least one database of the system) using a plurality of controllers in communication with the one or more servers, a first configuration associated with a first active file set of defined values stored in the at least one database; selecting a second configuration of the one or more configurations to execute, the second configuration associated with a second active file set of defined values stored in the at least one database; executing the second configuration using a set of targeted controllers of the plurality of controllers by: populating, using the file service, a second active file set in the database with values associated with the second configuration, translating, using the data service, the values of the second active file set into a protocol associated with the set of targeted controllers such that each controller of the targeted set can read the translated values, and transmitting the translated values to each controller of the second set.

The methods hereof can further comprise identifying a change in between the first file set and the second file set and deleting, using the file service, the first active file set from the at least one database.

Where the sequencing system comprises an output device or system, the method can further comprise notifying an output device or system of a changeover from the first configuration to the second configuration. In at least one embodiment, the step of notifying an output device or system of a changeover can comprise providing the output device or system access to the second file set. In certain embodiments, the output device or system is configured to interface with the at least one database and read the feedback data and data of the one or more configurations.

Still further, the method can comprise receiving, using the data service, feedback data from at least a portion of the plurality of controllers; translating, using the controller service, the feedback data into a uniform file format; and saving the feedback data in the uniform file format in the at least one database in accordance with an organization structure that correlates the saved feedback data with each controller from which the feedback data originated. In at least one embodiment, the feedback data is saved in the database is real-time data.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a schematic diagram of a conventional industrial automated system;

FIG. 2 shows a schematic/block diagram of an automated industrial system comprising a uniform sequencing system according to at least one embodiment of the present disclosure;

FIG. 3, subpart A shows a screenshot from the program hereof displaying a graphical representation of the mapped equipment and controllers in communication with the uniform sequencing system of the present disclosure; FIG. 3, subpart B shows a screenshot of a Service Installation Creator tab user interface according to at least one embodiment of the present disclosure, such interface for use in configuring a folder of a database of a uniform sequencing system, such folder associated with a particular controller; FIG. 3, subpart C shows an example of an .xml folder structure of the database in at least one embodiment of the uniform sequencing system of the present disclosure; and FIG. 3, subpart D shows a screenshot of an example system program overview, with each square under the upper layers (Phases, Operations and Procedures) representing the controllers (processing mapping) of a system program, and the lowest layer (Equipment Modules) representing the I/O-Control Module handling/mapping;

FIG. 4 shows two screenshots of user interfaces that can be associated with the sequencing system of the present disclosure, with the top screenshot showing the various steps of a selected configuration (in this case, flavor mane 43209073) and the real-time status of each step, and the lower screenshot showing additional detail on the selected operation or step of the configuration (here, BASE ADD OP) including all sub-steps associated therewith;

FIG. 5 shows screenshots of user interface windows that can be associated with the sequencing system of the present disclosure, with the top screenshot representing an interface through which setpoint values can be input for a particular step (here, FB BASE ADD OP), and the lower screenshot representing an interface through which setpoint values can be input for a particular sub-step (here, FB BASE ADD PH);

FIG. 6, subpart A shows a flow chart representative of a method for modifying a configuration (and the file set related thereto) using the sequencing system of the present disclosure;

FIG. 6, subpart B shows a flow chart of a method for switching an automated production system from a first configuration to a second configuration using the sequencing system of the present disclosure;

FIG. 7 shows a representative block diagram of at least one data flow between a database of the sequencing system and a controller (e.g., a programmable logic controller);

FIG. 8 shows a flow chart of a method for generating a report using the sequencing system of the present disclosure;

FIG. 9 shows a screenshot of a user interface for use with a SCADA system or otherwise, the data therein populated and maintained by the sequencing system of the present disclosure;

FIG. 10 shows a flow chart of a method for updating a SCADA system in communication with the sequencing system of the present disclosure with respect to a configuration or other value change;

FIG. 11 shows a schematic/block diagram of an embodiment of a sequencing system according to the present disclosure;

FIG. 12 shows a schematic diagram of at least one embodiment of the system represented in FIG. 11; and

FIGS. 13-19 show various dataflow examples that may occur in operation of the one or more software applications and/or in connection with a configuration running on the sequencing system of the present disclosure.

An overview of the features, functions and/or configurations of the components depicted in the various figures will now be presented. It should be appreciated that not all of the features of the components of the figures are necessarily described. Some of these non-discussed features, as well as discussed features, are inherent from the figures themselves. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is intended, with any additional alterations and modifications and further applications of the principles of this disclosure being contemplated hereby as would normally occur to one skilled in the art. This disclosure is intended to cover alternatives, modifications, and equivalents as may be included within the spirit and scope of this application as defined by the appended claims. While this technology may be illustrated and described in a preferred embodiment, the systems and methods hereof may comprise many different configurations, forms, materials, and accessories.

For example, the systems, methods and techniques of the present application will be described in the context of industrial manufacturing and automation systems. However, it should be noted that the systems, methods, and techniques of the present application apply in a wide variety of contexts including, but not limited to, all types of industrial automation and, more generally, any automated process that involves a plurality of component processors that are each responsible for operating one or more objects or devices.

In the following description, numerous specific details are set forth in order to provide a thorough understanding of the present disclosure. Particular examples may be implemented without some or all of these specific details. In other instances, well known process operations and/or system configurations have not been described in detail to not unnecessarily obscure the present disclosure.

Various techniques and mechanisms of the present disclosure will sometimes describe a connection between two components. Words such as attached, affixed, coupled, connected, and similar terms with their inflectional morphemes are used interchangeably, unless the difference is noted or made otherwise clear from the context. These words and expressions do not necessarily signify direct connections, but include connections through mediate components and devices. It should be noted that a connection between two components does not necessarily mean a direct, unimpeded connection, as a variety of other components may reside between the two components of note. For example, a workstation may be in communication with a server, but it will be appreciated that a variety of bridges and controllers may reside between the workstation and the server. Consequently, a connection does not necessarily mean a direct, unimpeded connection unless otherwise noted.

Furthermore, wherever feasible and convenient, like reference numerals are used in the figures and the description to refer to the same or like parts or steps. The drawings are in a simplified form and not to precise scale.

A general description of the framework components will now be provided, followed by a detailed description of the novel systems and methods of the present disclosure. It will be understood that many of the framework elements hereof are well known in the arts. Those skilled in the art will recognize many variants, modifications, and additions may be made to the general network structures and other configurations without departing from the scope of the claimed subject matter; indeed, it is intended that any such configurations are encompassed within the present disclosure to the extent they are compatible with the inventive systems and methods described herein.

The detailed descriptions that follow are presented in part in terms of algorithms and symbolic representations of operations on data bits within a computer memory representing alphanumeric characters or other information. A computer generally includes a processor for executing instructions and memory for storing instructions and data. When a general-purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines (e.g., a programmable logic controller in operative communication with one or more sensors and/or actuators) and thus may operate through those control signals to transform materials far removed from the computer itself.

An algorithm (instructions) is here, and generally, conceived to be a self-consistent sequence of steps leading to a desired result (for example, a series of steps, founded on a pre-condition, to accomplish some post-condition; in other words, taking input(s) A and generating result(s) B). These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be kept in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation.

Further, the manipulations performed are often referred to in terms commonly associated with mental operations performed by a human operator (such as “comparing”). No such capability of a human operator is necessary, or desirable in most cases, in any of the operations described herein which form part of the embodiments of the present application; the operations are machine operations. Indeed, a human operator could not perform the many of the machine operations described herein due to the networking and vast distribution capabilities of the present disclosure.

Useful machines for performing the operations of one or more embodiments hereof include general purpose digital computers, microprocessors, or other similar devices. In all cases the distinction between the method operations in operating a computer and the method of computation itself should be recognized.

One or more embodiments of the present disclosure relate to methods and apparatus for operating a computer in processing electrical or other (e.g., mechanical or chemical) physical signals to generate other desired physical manifestations or signals. The computers and systems described herein may operate on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher-level coding of the instructions that is interpreted to obtain the actual computer code. In certain embodiments, the software module may also include a hardware component, wherein some aspects of the algorithm are performed by the circuitry itself rather as a result of an instruction.

As used herein, the term “controller program” means and includes a program, perhaps written to a user's specifications, that causes a PLC or other controller to perform monitoring and controlling functions.

A controller program can be leveraged pursuant to techniques of the present disclosure via execution of one or more configurations. A “configuration,” as used herein, can comprise a set of sequences (i.e. a set of steps performed by a PLC or other controller), parameters (associated with one or more steps or other variables), and/or alarms. In at least one embodiment, a configuration may comprise multiple sequences that relate to each other. A configuration can be a set of sequences directed to a specific controller or can have one or more sequences directed to two or more controllers to facilitate cooperation therebetween (e.g., a single configuration can be directed towards filling pans with batter using a first controller, but as pans cannot be filled without batter on hand, such configuration can also include sequences directed towards a second (or more) controller for performing sequences to mix the batter).

“System program” or “system process” means and includes a program, perhaps written to a user's specification, that causes the industrial automated system as a whole to perform a specified process, including (but not limited to) running the configurations and controller program(s) on each PLC of the system in a specified way to achieve a desired result (e.g., to make a batch of sugar cookies). A system program can control an entire manufacturing line including, for example, instructing more than one controller (as defined herein) to perform functions, and can make configurations/sequences work together in the most efficient way.

“Discrete input” means an input which can only take one of two values, such as a switch. These inputs can be used transparently in the embedded logic and/or explicitly in the controller program, and are physical inputs. They are also often called digital inputs. “Analog input” means an input that can take on a continuous range of values, such as, for example, values related to pressure, temperature or flow. As used herein, “input” can be both discrete and analog input, unless otherwise specified. A sensor converts these values to a voltage, current or other electrical quantity that can be ready by the PLC or other controller. These inputs can be used transparently in the embedded logic and/or explicitly in the controller program and are physical inputs.

As used herein, “output” is a discrete or analog output used to drive an indicator or control actuator, such as an indicating lamp, a relay, or a valve position solenoid.

“Healthy” is a state of a physical input or logical input which indicates that the input is considered to be within normal limits. “Unhealthy” is a state of a physical or logical input that indicates that the input is considered to be outside of normal limits, requiring user notification and possible corrective action by the operator, configuration and/or controller program.

“Setpoint” is an analog value entered by the user indicating the high or low limit at which an analog input is considered healthy. Should the analog input exceed (go above for a HIGH setpoint or go below for a LOW setpoint) the setpoint, an unhealthy condition exists.

In the following description, several terms that are used frequently have specialized meanings in the present context. As used herein, the term “network” can mean and include two or more computers that are connected in such a manner that messages/data may be transmitted therebetween. Unless otherwise specified, a network can include a local area network (“LAN”), a wireless local area network (“WLAN”), a wide area network (“WAN”), a virtual private network (“VPN”), a global area network (“GAN”), an interconnection of any number of the foregoing (for example, multiple LANs connected together), or any combination thereof (for example, a LAN connected to a WAN using any number of router, hubs, switches, integrated access devices, multiplexers, or other internetworking devices). Such networks may optionally be secured, depending on the desired use case, for example using end-to-end encryption such as hypertext transfer protocol secure (HTTPS) and the like, via secure socket layer (SSL), and/or utilizing other security frameworks known in the art.

In such computer networks, typically one or more computers/processors operate as a “server” which runs one or more applications capable of accepting requests from clients and giving responses accordingly. Servers can run on any computer including laptops or dedicated computers, which individually are also often referred to as “the server” and typically comprise—or have access to—large storage devices (such as, for example, hard disk drives and/or other databases) and further comprise communication hardware to operate peripheral devices such as printers or modems. Servers can be configured for cloud computing, which is Internet-based computing where groups of remote servers are networked to allow for centralized data storage. This may be particularly useful when the systems and methods hereof are deployed in conjunction with supervisory control and data acquisition (SCADA) software (or the like). Such cloud computing systems enable users to obtain online access to computer services and/or resources via workstations, including without limitation mobile clients.

Other computers, herein termed “workstations” or “clients” provide a user interface such as a human machine interface (“HMI”) (which may be stand-alone, or part of a SCADA or other system) so that system engineers can access the network resources, such as programmable logic controllers (“PLCs”), remote terminal units (RTU), and/or proportional-integral-derivative controllers (PIDs) in communication therewith (each a “controller”), and/or input/output (I/O) devices associated such controllers.

Users activate computer programs or network resources to create “processes” which include both the general operation of the computer program along with specific operating characteristics determined by input variables and its environment. A “module” refers to a portion of a computer system and/or software program or application that carries out one or more specific functions and may be used alone or combined with other modules of the same system or program. For example, in at least one embodiment, each PLC may comprise a control module comprising subsequences or other instructions related to the peripheral device or object in communication therewith.

In general, the disclosure of the present application provides novel systems and methods for providing flexible automation processes that are accurate, reliable and easily scalable. In at least one exemplary embodiment, such inventive processes are driven via a novel sequencing system configured to act as a middleware platform or module between one or more output devices or a system (e.g., a SCADA and/or HMI (or similar system employed)) and each individual controller (e.g., PLC) in the system, thus reducing the need for discrete complex programming sequences specific to any one PLC, RTU, PIDs, or an input/output (I/O) device. The systems and methods hereof allow for cross-platform interoperability, high security, and reliability.

Furthermore, the systems and methods hereof are highly dynamic and customizable (even during run-time). In certain iterations, the novel system of the present disclosure comprises a server, a database having a set schema in communication with the server, at least one software application that is executable by the server, and a plurality of PLCs, PIDs, RTUs, or other devices (each associated with one or more I/O devices) in communication with the server and/or database. While a SCADA, HMI or similar system may also be in communication with the server, this is not required.

The software application comprises at least one set of controller drivers. In at least one embodiment, the set of controller drivers will include a driver capable of communicating with a controller within the system having a certain protocol and interpreting data from such controllers into a language that is readable by and/or corresponds with the schema of the database.

In general, a driver is a protocol interface to a piece of hardware (e.g., such as a PLC/controller). Controllers manufactured by different entities have different proprietary protocols and other disparate structures and organization (e.g., the digital memory of one PLC may be organized in a different manner than one of another manufacturer or even between different PLC models designed by the same manufacturer). Because there are typically a large number of controllers within an industrial automation system and all are not manufactured by the same entity (or, even where controllers are manufactured by the same entity, they may have different hard coded PLC logics), communication gaps exist in conventional systems that require all logic changes to be made manually at the PLC/controller level (i.e. in each controller's particular programming language). The present inventive system overcomes this impediment through use of the at least one set of controller drivers that enable direct and bidirectional communication with all controllers of the system from a centralized, and operationally remote, location. As is described in more detail herein, the systems hereof standardize the various PLCs languages/protocols, which facilitates not only ease of use by a user, but also allows for real time changes to the system and/or processes performed thereby.

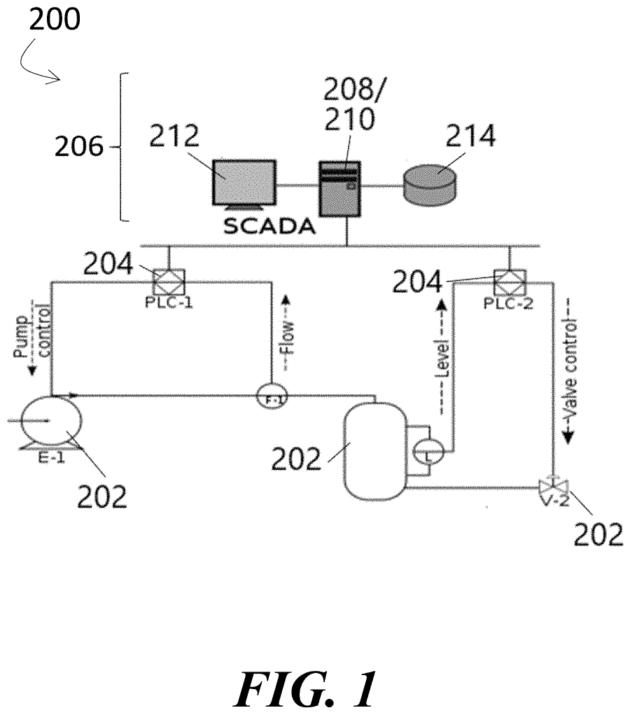

Now referring to FIG. 1, a schematic of a conventional SCADA automated processing system 200 is shown for contextual purposes. Such systems 200 may comprise one or more I/O devices 202, for example flow and temperature sensors, actuators, final control elements, and the like. The I/O devices 202 represent components in a process system that may perform any of a wide variety of functions and are often in the “field”—i.e. physically located at the plant. For example, I/O devices 202 that comprise sensors could measure a wide variety of characteristics in the process system such as, for example, temperature, pressure, or flow rate. Also, I/O devices 202 that are actuators could alter a wide variety of characteristics in the process system. While sensors and actuators are the specific examples discussed here, I/O devices 202 could represents any other or additional components in any suitable process system.

The system 200 includes one or more controllers 204. Each controller 204 may be a machine-level controller that performs various functions to support the operation and control of one or more the I/O devices 202 in communication therewith. For example, in at least one embodiment, a controller 204 could be associated with a particular piece of industrial equipment (such as a boiler, a robot, or other machine) and coupled with the sensors and actuators (202) thereon. In such example, the machine-level controller 204 could log information collected or generated by the I/O devices 202, such as measurement data from the sensors or control signals for the actuators. The controller 204 could also execute applications that control the operation of the I/O devices 202 in communication therewith.

Each controller 204 includes any suitable structure for providing access to, control of, or operations related to a machine or other individual piece of equipment in communication therewith (whether via the I/O devices 202 or otherwise). As a particular example, each controller 204 could represent a PLC, PID, RTU, or any other industrialized I/O controller module and its associated distributed electronic processors for running a real-time operating system.

Especially in the context of PLCs, the controllers 204 are designed to efficiently undertake real-time control of the I/O device(s) 202 with which they communicate and operate autonomously on the near-real time control of the process. For instance, a controller 204 can receive data from a first I/O device 202 (e.g., a sensor) and, based upon the received data, control a second I/O device (202 (e.g., an actuator, drive, or the like) in accordance with that controller's 204 program (e.g., in a case of a PLC, that PLC's complied PLC code). These controllers 204 recognize a source and/or destination of the data by way of a symbol and/or address associated with a source and/or destination. Thus, a controller 204 can recognize a particular I/O device's 202 identity when data is received and thereafter deliver control data to an appropriate device 202.

One or more operator stations (not shown) may be in communication with each controller 204. Operator stations, for example, a computer, laptop or other computing device with a user interface, can provide user access to controllers 204 (and the related I/O devices 202) with which they are in communication. As an example, the operator stations can allow operational engineer users at a plant to review the operational history of particular I/O devices 202 using information collected by the related controller(s) 204. The operator stations can also allow the users to adjust the operation of the I/O devices 202 or controllers 204. Notably, in conventional systems such as system 200, adjusting operation of the controllers 204 and related I/O devices 202 is performed the controller 204 level (i.e. it must be done on location by accessing an operator station in communication with the particular controller 204 where changes are to be made.

One or more networks may be coupled with the I/O devices 202 and/or controllers 204 to facilitate interaction therebetween and/or with one or more controllers 204. In at least one embodiment, various routers may be employed to facilitate such connections as is known in the art. Further, one or more networks (including, for example, redundant networks) may be coupled to the controllers 204 to facilitate interaction between various controllers 204. Each network be any suitable network, such as and without limitation, an Ethernet network, an FTE network, a WAN, or a LAN.

The system 200 may further comprise one or more switches/firewalls coupled to the networks as is known in the art.

In the context of industrial automation, various controllers (whether controllers 204, servers, or the like) may be established in a hierarchical network, each optionally with an operator station. While the controllers 204 such as PLCs, PIDs, RTUs and the like are typically in direct communication with, and dedicated to, one or more I/O devices 202, other layers of controllers could also be provided. It will be appreciated that the schematic depicting the system 200 in FIG. 1 is simplified in this context; there may optionally be two or more hierarchical layers of controllers. For example, and without limitation, a supervisory controller may be in communication with multiple PLC controllers 204 (each of which may comprise their own operator station) at a plant supervisory level. Additionally, one or more coordinating computers/controllers may be in communication with one or more supervisory controller(s) at a production control level, perhaps if multiple plant locations are involved. Such functional level organization is known in the art and it will be understood that any variation thereof may be employed with the systems of the present disclosure.

The SCADA automated processing system 200 further comprises a central control system 206 that is the portion of the system that gathers data on the process and sends control commands to the field-connected I/O devices 202 via the controllers 204 and/or any other intervening controllers. The control system 206 can include both computer hardware 210 and software 208 responsible for communicating with the controllers 204 and, as mentioned above, also includes the HMI component 212 running on one or more operator workstations or clients. The communication between the central control system 206 and the controllers 204 is typically limited to only recipe/type process selection (provided such recipes/processes are preprogrammed at the controller level) and general machine/line status. For example, a central control system 206 may communicate changes to system controllers 204 to alter rate setpoints and batch quantities (e.g., material amounts, total production targets, etc.).

It will be appreciated that the schematic depicting the control system 206 in FIG. 1 is simplified; indeed, there may optionally be two or more hierarchical layers of controllers and user interfaces as is known in the art (e.g., controllers and interfaces at the field level (direct control), at the plant supervisory level, and/or at the production control level, perhaps if multiple locations are involved).

In smaller systems 200, for example one for management of a single plant, the central control system 206 may comprise a supervisory computer composed of a single personal computer or laptop, in which case the HMI component 212 runs locally thereon. However, as will be appreciated by one of skill in the art, in larger systems 200 that manage one or more plants and/or other processing facilities, the central control system 206 can comprise a master station that includes several HMI components hosted on multiple client computers, multiple servers for data acquisition, distributed software applications, and disaster recovery sites. Central control systems 206 may optionally comprise multiple servers configured in a dual-redundant, hot-standby, or other known-formations to increase the integrity of the system 200.

The central control system 206 communicates with the other components of the system 200 via wired communication and/or via a data network (e.g., a LAN and/or WAN) as is known in the art.

Additionally, the system 200 can further comprise a data server layer 214 in communication with the control system 206 (via a network or otherwise). The data server 214 can comprise any component, server, database or structure suitable for storing and facilitating retrieval of information. Although shown as a single centralized component coupled with the hardware 210 in FIG. 1 (e.g., via a network), the data server 214 can be located elsewhere in the system 200, or multiple data servers 214 can be distributed in different locations in the system 200. In at least one embodiment, the controllers 204 can be in either direct communication with the data server layer 214 or communicate indirectly via networks or buses as is known in the art.

To implement the system 200, the SCADA software 208 is programmed with the network address of each controller 204 and specific information in the I/O devices 202 is mapped to data registers within the I/O devices 202. By polling each controller 204 and requesting the contents of the desired registers thereof, the SCADA software 208 can display a general status of the entire system 200. However, while conventional systems 200 can provide a high-level overview of the system environment, such systems cannot drive independent controllers 204 in real-time, push system-wide value updates (e.g., to modify configurations, batch size within the same configuration, or the like), provide a visualization of detailed system wide changes without intensive programming, or provide a detailed status of specific I/O devices 202 in the system 200.

A lack of uniformity exists across system/process boundaries in conventional control systems 206, as well as a lack of uniformity between controller manufacturers, software vendors, and customers. Accordingly, a substantial amount of ad-hoc coding is required to automate a process and ensure the various pieces of the system 200 can adequately communicate. While a few plug-in packages exist for the purpose of bringing a common “look and feel” and operational consistency to all machines within a process line (e.g., PackML, S88, and the like), such packages require stopping the system and performing controller-compiled program changes and SCADA system changes to accommodate significant updates to reflect impactful changes to an underlying process. In other words, even with such plug-ins, ad-hoc coding is still required at a controller, and, depending on the change, the HMI/SCADA level(s) to implement a new process and/or to switch over and manufacture a new product with the automated system.

Data associated with conventional industrial automated systems is created, delivered, and/or stored with a flat namespace data structure. In other words, all that can be discovered by reviewing data received and/or output by a controller 204 in conventional systems 200 is the identity of an I/O device 202 (e.g., an actuator or sensor) and a status thereof. This PLC architecture operates efficiently for real-time control of a single device 202 at the controller 204 level; however, problems arise when data from industrial controllers 204 is desired for use by a higher-level system. For example, if data from the controller 204 is needed for use by a scheduling application, an individual familiar with the controller 204 must, in each instance, determine what data is required, sort the data, package the data in a desired format, and map such data to the scheduling application. This can introduce another layer of software to the system 200 and provide opportunities for confusion in an industrial automation environment.

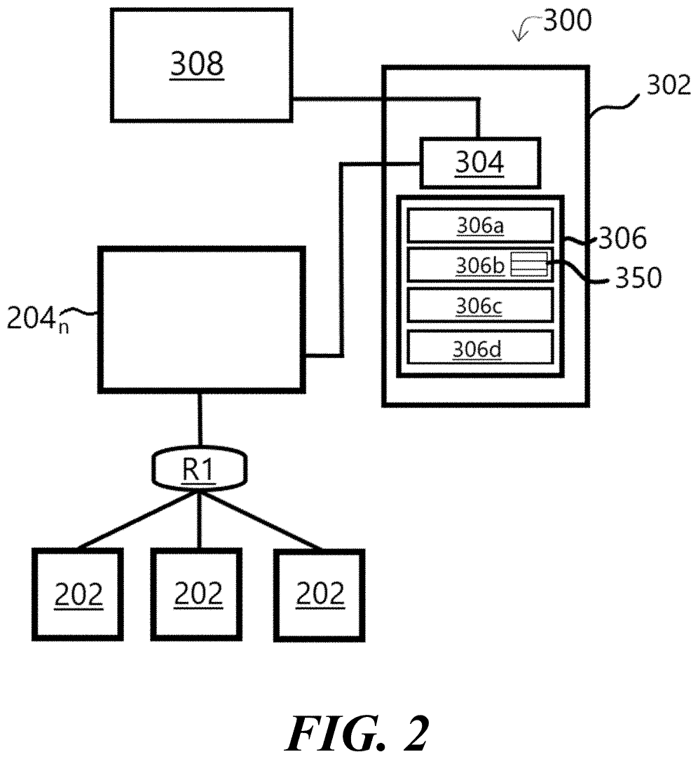

Now referring to FIG. 2, a schematic of at least one embodiment of a novel sequencing system 300 for use in executing one or more system programs using industrial automation controllers is shown. The sequencing system 300 is a packaged solution that can be used in conjunction with a conventional system 200, for example, and is configured to display and push transition conditions and sequence step states of the I/O devices 202 (in communication with a plurality of controllers 204) without requiring additional programming at the controller 204 or at any client level (e.g., an HMI component 212 or SCADA central control system 206 level). Instead, the sequencing system 300 can centralize codification of and communication with industrial automation controllers 204 and I/O devices 202, which enables an operator to make systemwide run-time changes in real-time.

As previously noted, in industrial automated systems, each system program has one or more unique configurations, written to desired specifications, to control a sequence of events in one or more I/O devices 202 for that particular system. This can be simple (e.g., where the system comprises one or two controllers 204, each coupled with a separate I/O device 202), extremely complex (e.g., where the system comprises a plurality of controllers 204, located in various physical locations and geographies, and each of the controllers 204 is in communication with various I/O devices 202), or anywhere in between.

PLCs and similar devices (e.g., controllers 204) operate by gathering information from various inputs (i.e. I/O devices 202) and processing the data—typically using Relay Ladder Logic, a type of computer program based on Hard Wired Relay Logic, or other higher-level languages supported by Sequential Function Charts, Function Blocks, Structural Texts, or Instruction Lists. At system set up, for example, the analog and discrete signals to be monitored (via the I/O devices 202 of the industrial automation system) are connected to the appropriate inputs of the controllers 204, and the I/O devices 202 to be controlled are connected to the appropriate controller 204 outputs. In operation, the I/O device 202 data is gathered and manipulated by the controller program (i.e. an established set of conditions and sequences) that runs locally on the relevant controller 204 and, based thereon, the controller 204 sends appropriate output signals to control the operation of the equipment to which it is connected (I/U device 202).

By way of reference, controllers 204 can use discrete inputs and analog inputs (sensors) to supply data to the control application. A discrete input has two states: ON or OFF. Depending on how the input sensor is configured at the controller 204 level, ON can be the healthy state or OFF may be considered the healthy state. An analog input is a varying input that monitors, for example, pressure, temperature or flow. Temperatures are usually measured using thermocouples or resistance temperature detectors. Analog measurements are usually made using current loops (4-20 mA) or voltage inputs (1-5V).

In controller hard coded programs, analog inputs can have setpoints that are explicitly defined operational limits for each sensor (i.e. I/O device 202). When the measured value exceeds (or drops below) the setpoint values, the PLC is programmed to take some action. In all cases, with conventional systems, significant planning and design are required to implement such an automated production process that can involve hundreds (if not thousands) of machines, computers, and program logic to facilitate proper operations of the respective sequences.

The sequencing system 300 of the present disclosure introduces an industrial sequencing logic configuration for universally translating disparate higher level command structures across controllers 204 and I/O devices 202 and displaying such universal code in a centralized location (e.g., a client or workstation such as an HMI component 212). In other words, the inventive sequencing system 300 facilitates execution of a system program by initiating the relevant configurations (e.g., sequence steps thereof), and modifying a plurality of variant value inputs to the controllers 204 at each sequence step, at the controller 204 level. Certain embodiments of the sequencing system 300 also allow for a user to make precise modifications of the production process by driving controllers 204 in real-time from a single, central location (e.g., where a SCADA is in communication with the system 300, a central control system 206). Introduction of the sequencing system 300 can centralize up to one hundred percent (100%) functionality of any industrial automation system. Use of this system 300 is not confined to batch processing; rather, it can be easily configured discretely to alter the procedural models in a process, as well as the equipment model in the same process.

The inventive system 300 comprises a server 302 and at least one database 304 having a set schema in communication with the server 302. The system 300 further comprises one or more software applications 306 executable by the server 302, such software application(s) 306 configured to, at a minimum, bidirectionally communicate with controllers 204 (and associated I/O devices 202) of an industrial automation system in communication with the system 300, translate data received from the controllers 204 into a uniform datafile format that correlates with and is storable by the set schema of the database 304, and update the at least one database 304 with the translated data. Such software applications 306 can also be configured to recognize an update to the data in the database 304 (e.g., a system program change), translate such updated data into a format that is readable by each controller 204, and push such translated data to each controller 204 to achieve synchronous modification of controller 204 operations, thus implementing the system program change.

The sequencing system 300 can be in communication with one or more controllers 204 (represented as 204n, where n=any whole number, including for example 1, 2, 3, 4, 5, . . . 10 or any number greater than 10), each of which are in communication (via a network or otherwise) with one or more I/O devices 202 as previously described in system 200. The controllers 204 can also be in communication with each other (i.e. to broker activities between multiple controllers 204) and run programs thereon as is known in the art.

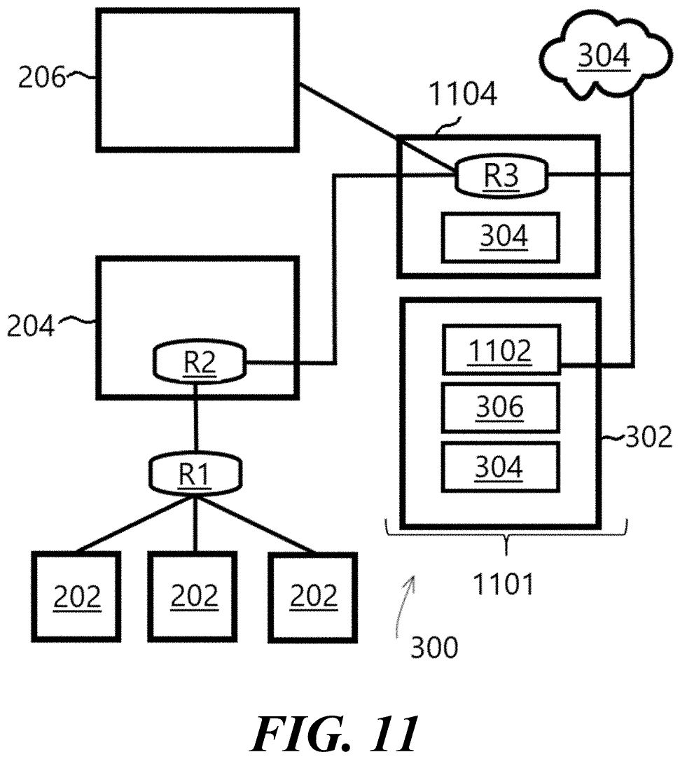

Any number of controllers 204 may be utilized with the system 300. As shown in FIGS. 2 and 11, the controllers 204 can be networked with one or more routers R1, R2, R3, and/or Rn (where n=any whole number) to facilitate communication with each of their respective I/O devices 202; however, routers need not be employed and the controller(s) 204 may be in communication with the one or more I/O devices 202 through wired or other wireless means.

The system 300 can optionally be used in conjunction with an output device or system 308. In at least one embodiment, the output device or system 308 comprises one or more clients or workstations. In another embodiment, the output device or system 308 comprises one or more of the central control system 206 of system 200 (e.g., a SCADA system or other forms of industrial automated systems), an enterprise resource planning (ERP) system, and/or scheduling software. Alternatively, the output device or system 308 can simply be an HMI accessible via a computer or otherwise (e.g., the system 300 includes controllers 204, I/O devices 202, and an HMI 308).

Each component of the sequencing system 300 will now be described in additional detail. The server 302 can comprise a conventional personal computer, a laptop, a tablet, or a mobile device comprising a central processing unit (CPU), or any other device or system comprising a processor that is capable of executing the software 304 instructions and interacting (directly or indirectly) with other components of the system 300 to perform the objects and methods of the present disclosure. Additionally, the server 302 can be a stand-alone server, a rack server, a blade server, a tower server, or any other server configuration desired (and may comprise one or more servers 302 working in concert with each other), depending on the complexity of the industrial automation system and/or the system intended use and configuration needs. The server 302 can further comprise interface circuitry (not shown) sufficient to exchange information with a host (e.g., the central control system 206) and the memory or database(s). Alternatively, the one or more software 306 components can be implemented in an embedded system within a central control system 206 of a SCADA platform or otherwise such that an independent server 302 is not required.

The server 302 is in communication with at least one database 304, at least one of which comprises a relational database 304 having a set schema in communication with and/or accessible by the software applications 304. Such database 304 can comprise the same database in which the software 304 is stored, can be local to the server 302 (e.g., on-prem) but independent of the database in which the software 304 is stored, or can be a remote database accessible by the server 302 as is known in the art (e.g., stored in the cloud).

In at least one embodiment, the one or more databases 304 comprises a structured query language (SQL) database, an SQLite database, and/or a flask database. Additionally or alternatively, the one or more databases 306 can be Eclipse Mosquito™ and one or more I/O device 202 drivers (OPC_UA).

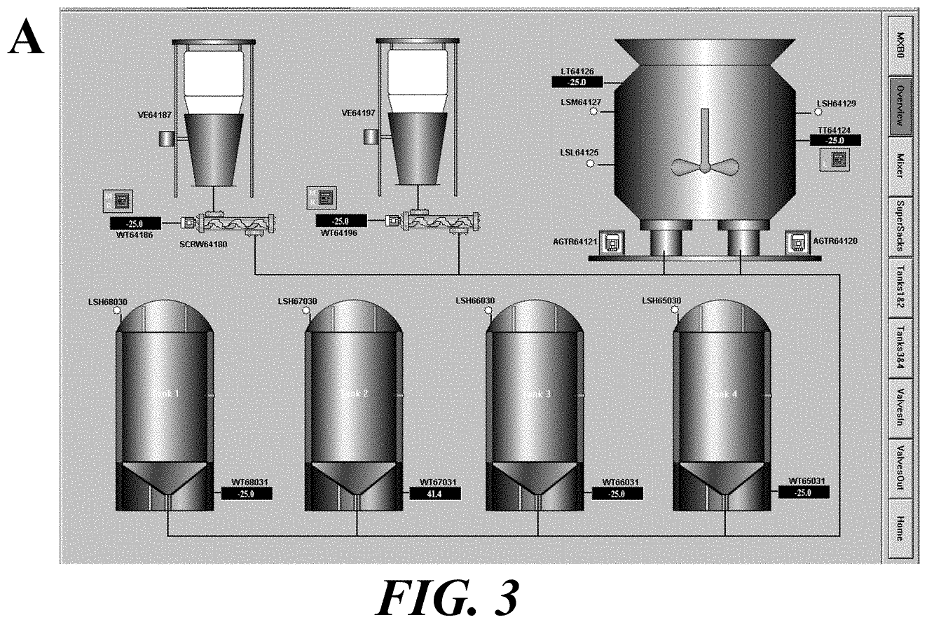

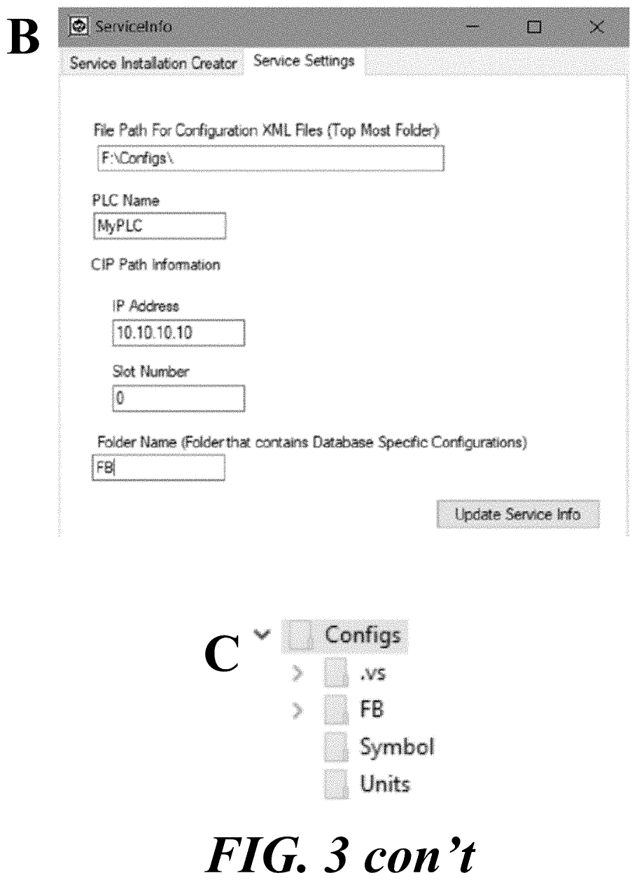

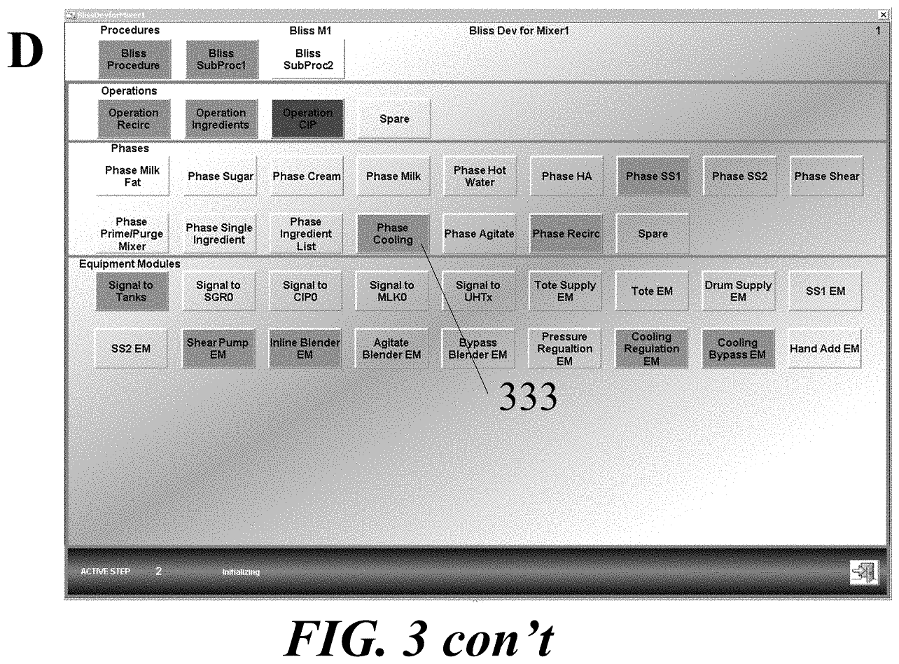

The set schema of the database represents a logical configuration of all or part of the relational database 304 that stores a plurality of datafiles that are readable and writable by the software application 306 and, if applicable, readable and/or displayable by an output device or system 308.

Where system 300 is employed in connection with multiple controllers 204, details on each controller 204 are mapped into the database 304 and different configurations for each are set up as desired. In at least one embodiment, at setup a unique identifier is assigned to each controller 204. For example, the identifier convention may be numerical, such as a first controller 204 is assigned a naming value of “1,” a second controller 204 is assigned a naming value of “2,” and so forth; however, it will be appreciated that any naming convention can be employed. FIG. 3, subpart A, shows a graphical representation of multiple controllers 204 in communication with the system 300 mapped into the database 304 that can be produced by the system 300 (graphics and reporting functionality is described in additional detail below). In at least one embodiment, each of these controllers 204 have one or more dedicated folders within the database 304 that store datafiles (i.e. value-based instructions) related to their operation.

The screenshot shown in FIG. 3, subpart B relates to a particular PLC controller 204 that is identified as “MyPLC” within the system 300. This controller 204 has one or more specific folders named “FB” within the database 304 in which datafiles related to that controller 204 can be stored. In at least one embodiment, such folders can contain a variety of input fields to be populated with values related to the operation status of each I/O device 202 in communication therewith. Accordingly, feedback received from each controller 204 regarding itself and its related I/O devices 202 can be input into these fields in real-time so that the actual operational status of the I/O devices 202 can be monitored and tracked from a central location (i.e. via a client output device 308 accessing the database 304).

In at least one embodiment, the datafiles are stored in the database 304 in a predefined folder structure (e.g., a folder tree or ladder structure or any other structure now known or hereinafter developed that can be useful in the present application) (see, e.g., FIG. 3, subpart C). The datafiles can be static or semi-static and, for example, can have XML, SCV, JSON, MDF, NDF, LDF, or any other file formats that are readable by both the output device or system 308 (where applicable) and the software application 306, and are also capable of being translated by the one or more software applications 306 into languages/values each controller 204 can understand.

The at least one database 304 also comprises one or more tables (e.g., in an SQL database) or other database structures for storing one or more series of user-defined process steps for executing a logic (e.g., step or state, or a combination of both) that drives a particular production process by driving the controller programs of the plurality of controllers 204 (e.g., PLC) mapped into the system 300 in a certain way. In other words, this portion of the database 304 stores values related to one or more configuration options for running system programs using the controllers 204 and related I/O devices 202 to produce an end-product (such as, for example, producing batches of baked goods or the like). In at least one embodiment, each configuration is stored in a different file such that a user can easily select which configuration(s) should be pushed to the related controllers 204 and all folders, or other data structures, are mapped to the hardware (i.e. controllers 204 and I/O devices 202) of the system 300.

FIG. 3, subpart D shows a screenshot of a graphical user interface of the system 300 that represents the steps of at least one configuration of a system program to be executed by the sequencing system 300, with each box representative of a different step of the process (e.g., sequence step 333 “Phase Cooling”). This representation can also potentially include one or more sub-steps affecting one or more controllers 204 and I/O devices 202, where applicable and/or desired. Configurations can be written in accordance with ANSI/ISA-88 (“S88”) or any other standard or model as desired.

In at least one embodiment, database structures for the configuration information are stored in the same database 304 and/or location as the controller-specific folders; however, it will be appreciated that the controller-specific folders and configuration information can similarly be stored in distinct databases 304. Storing the configurations independently of the controller-specific folders can allow for certain database management techniques and/or enable such data to be backed up and/or otherwise copied (e.g., to make off-line edits) and even validated. In at least one embodiment, the at least one database 304 comprising the configuration information (and related data) is included within an IT closet that is remote from the server 302 and other databases 304 of the sequencing system 300.

The database structures for the configurations can operate as pivot tables for use with the controller 204-specific datafiles populated by the software application 306. For example, a user can load various distinct configurations into the tables or folders (all stored in the uniform datafile format)—such as a first configuration for preparing 55 batches of sugar cookies (configuration 1), a second configuration for preparing 100 batches of brownies (configuration 2), a third configuration for preparing 1,000 gallons of chocolate milk (configuration 3), and a configuration recipe for preparing 1,000 gallons of 2% milk and bottling the batch in 1-gallon containers (configuration 4). When a configuration is selected to be run, an “active file set” is created in the database 304 within a predefined folder structure that corresponds with the structure of the controller-specific folders in the database 304. In at least one embodiment, the folder structure is organized to mimic a traditional PLC ladder logic to aid in troubleshooting for technicians and to also allow for more context to be easily accessible for more competent operators.

By way of a non-limiting example, for configuration 2, the steps are those shown in Table 1 below (it will be appreciated that these steps are simplified as compared to those typically used in industrial automation systems only for the purpose of conveying the concept in a concise manner).

TABLE 1
Configuration 2 Steps

| Step | Controller | Step Description, Sub-Steps, and |
|---|---|---|
| Sequence | Identification | Variant Values |
| 1 | 1 | Heat oven to 375° |
| 2 | 2 | Fill tank X with 100 liters of |
| | | fluid from input tank. |
| | | Maintain a first temperature |
| | | within tank X within a specified |
| | | temperature range. |
| | | Proceed to SEQ#3 when |
| | | temperature hits the first |
| | | temperature. |
| 3 | 2 and 3 | Add dry ingredient mixture Y to |
| | | tank X. |
| | | Proceed to SEQ#4. |
| 4 | 3 and 4 | Mix tank X for a specified time |
| | | period. |
| | | Proceed to SEQ#5 when time |
| | | period achieved. |
| 5 | 4 | Deposit mixture in tank X to |
| | | tray Z. |
| | | Proceed to SEQ#6. |
| 6 | 5 | Place tray Z in oven heated at |
| | | SEQ#1 for specified time |
| | | period. |

Each step can include a series of sub-steps that leverage one or more I/O devices 202 in communication with the relevant controller(s) 204. Further, one or more of the configuration steps can be executed in sequence or concurrently as is known in the art as defined in that system program. It will be appreciated that, while the steps in Table 1 only show one controller 204 associated with each step, any number of controllers 204 and their associated I/O devices 202 can be utilized in a particular step or sub-step and multiple values may be input for each I/O devices 202 depending on the desired outcome. The available combinations allow for exceedingly complex system programs to be executed by the system 300.

Configurations can include a plurality of variant fields in which desired values are input for each step of the program sequence. Such variant fields may include, for example, setpoint values (both point and ranges) for specific controllers, conditional values, discrete values, transition conditions, acquire and release relations, and any other values that can be useful in operating a plurality of controllers 204 to perform a desired system program.

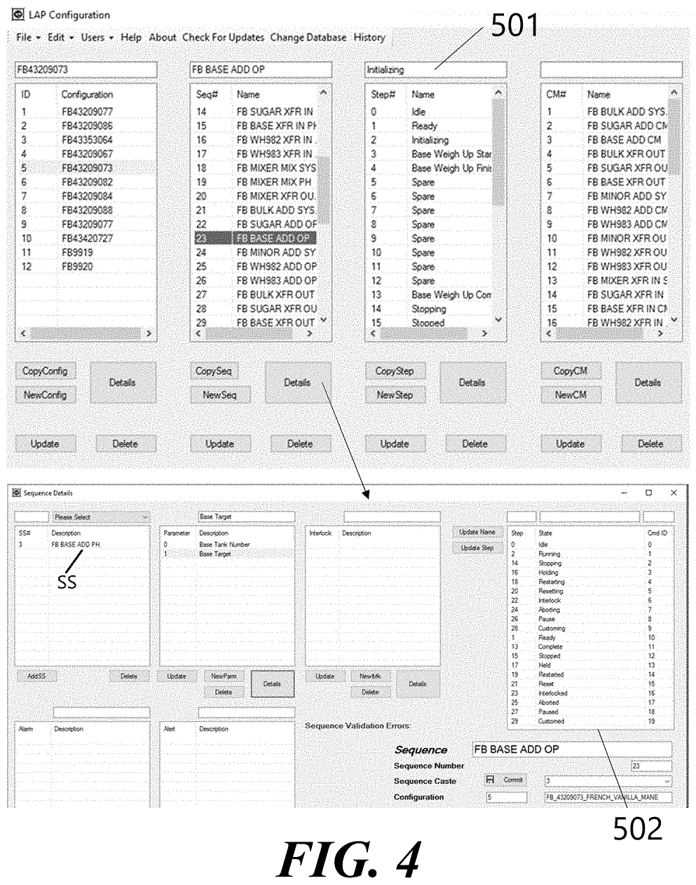

An example of a somewhat more involved configuration is represented in FIG. 4, which shows screenshots of two user interfaces that can be used in connection with at least one embodiment of the system 300. There, the selected configuration (here configuration FB43209073 (ID 5)) comprises a series of sequences (each labeled as Seq#), with each sequence comprising a series of steps (each labeled Step# and listed in column 501 (with Step#2 Initializing of SEQ#23 being the step that is active)), and each step potentially comprising one or more sub-steps (labeled SS# in the lower screenshot entitled “Sequence Details”). As shown in the lower screenshot, details of the selected sequence can be provided, including any sub-steps (SS) thereof. Here, FB BASE ADD OP is sequence #23 of the configuration and includes 1 sub-step (SS#3, FB BASE ADD PH).

Additionally, a real-time status update of each step (i.e. the state model) can be displayed updated in real time (see column 502). In at least one embodiment, the state model defines what step numbers mark the beginning and end of a state. For example, step ‘0’, in column 502 is the beginning of state “Idle” (note that step 0 is also named “Idle” (see column 501)). Step 1 is “Ready.” State “Running” starts at step 2 (Initialization), with its conclusive step being “Complete.” Step 13 (Base Weigh Up Complete) is the “Complete” of state “Running.” In this embodiment, the far right sub-column of column 502 is labeled “Cmd ID,” and is used to indicate an integer value that a sequence receives to force it to move to a certain state. For example, when sequence #23 receives a ‘1’ value for a command, it assumes step ‘2’, which is the first step of state “Running” and will continue to advance as configured through the next steps as such, unless it receives a difference command value as is known in the art. (Typically, as noted above, a sequence will advance through “Running” until it reaches its configured “Complete” step). A novel feature of the present system 300 is the flexibility provided to the state or other model employed. For example, a user can easily rename “Running” to “Executing” by modifying those values in the database 304 and, thereby expand or contract the number of steps it consumes as needed and/or desired.

Each file set related to a particular configuration stores all procedures and controller 204-specific setpoint and other parameter values at each step and sub-step of the selected configuration. The system 300 can also employ one or more flags, tags, registers, or address values as is known in the art to indicate changes made to a configuration stored within the database 304. As used herein, a flag is a tool or method for assigning and referencing one or more memory locations within a data table or folder of the database 304. It will be appreciated that flags are identified by different terms by different manufacturers (e.g., Allen-Bradley uses the term “tag”); however, the use of “flag” herein covers all such iterations. In at least one embodiment, a flag can be alphanumeric and labeled pursuant to the user's preference. Register and address values can also be employed to indicate a memory location within the files as is generally known in the art. In operation, the data in the file set can be turned into a call list to transfer to each controller 204 associated with performing the steps of that configuration.

Perhaps more specifically, the steps of each configuration can be loaded into a table of the database 304 and include a series of steps/sequences to be executed by various controllers 204 and associated I/O devices 202 in communication with the system 300, with each step associated with specific setpoint, conditions, or other value(s) for the related controller(s) 204. The setpoint values comprise one or more sets of coded values that can be pushed to each applicable controller 204 for such controllers 204 to interpret using the controller hard coded programs native thereto in connection with running the system program. Due to the vast scale of variants that can be adjusted using the system 300, it is possible to reconfigure and adjust the functional outcomes of the controllers 204 as desired. For example, and without limitation, 5,000-20,000 value data points or as many variants as needed may be used, which may include, for example, setpoints and ranges, process time, accumulated time, process variables, conditional requirements, etc., for each of the I/O devices 202 connected to one or more controllers 204. Further, such setpoint values can be used to turn controllers 204 on or off as required for a configuration; for example, a configuration may only require use of 100 controllers 204 and 450 I/O devices 202 where there are 1,000 controllers 204 and 12,000 I/O devices 202 available for use in the underlying industrial automation system. By including setpoint values in the file set that reflect inclusion or removal a controller 204 from participating in a system program altogether, configuration changeovers that require completely different equipment can be easily implemented.

As noted above, the user-defined values do not modify the underlying hardcoded logic of the controller programs themselves, but rather adjust the setpoint values within the established instructions of such controller 204 programs.

Set up and implementation of a system program can be performed by a user defining sequences of steps and sub-steps, and recording setpoint values, boundaries, and parameters for each controller 204 mapped to the system 300 with respect to each defined step (and any sub-steps) in a table of the database 304 associated with that particular configuration. Alarms and other criteria as is known in the art can also be incorporated into such a configuration.

In at least one embodiment, value data is entered for each step (and sub-step) and, if one or more controllers 204 and/or I/O devices 202 in communication with the system 300 are not required for one or more steps or sub-steps, data indicative of non-use is input for those controllers 204 at the appropriate steps/sub-steps. By way of non-limiting example and as is described in further detail below, when a user selects configuration 2 to run from the database 304, the values in the table associated with configuration 2 are automatically populated into the folders of the active file set (e.g., via operation of file service 306a), and the application 306 pushes those values to the appropriate controller(s) 204 as described below.

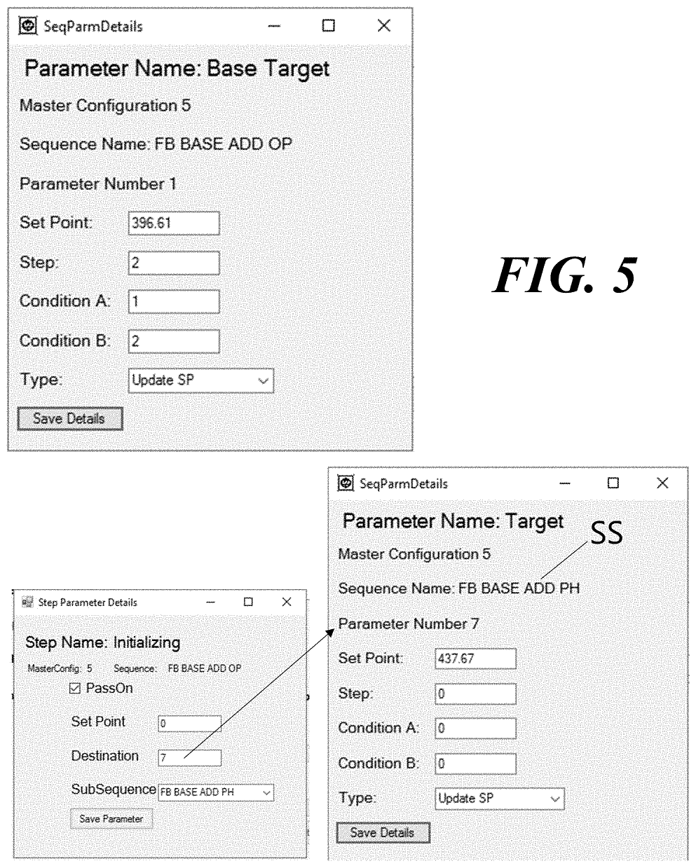

FIG. 5 shows examples of user interfaces that can be used with the system 300 and through which values/variables can be entered as described herein to define a particular step of a configuration. In FIG. 5, both sequence parameters shown are part of the configuration termed “Master Configuration 5,” with the “Base Target” sequence parameter associated with sequence “FB BASE ADD OP” and its condition values defining locations in the step model. The sub-step identified as “Target” is associated with sequence “FB BASE ADD PH” of the Master Configuration 5, which has a setpoint of 437.67. In at least one embodiment, when the sequence containing the step parameter (setpoint value) is active in the controller 204, which is monitored by the data service 306b (described below) via handshakes 422 (as described below and as known in the art), the data service 306b pushes the step to the next destination (information that can be associated with each sequence of a configuration table (for example, and without limitation, the values shown in columns 502 of FIG. 4)). For example, if step parameter FB BASE ADD OP is identified as having a destination of “parameter 7, when the step achieves the setpoint therefore (here, 396.61), the configuration advances to “Destination 7” which is sub-step/sequence FB BASE ADD PH, the previous setpoint (associated with step FB BASE ADD OP) is overwritten in the controller 204, and the new setpoint associated with the destination sub-step (here, 437.67) is pushed to the controller 204.

Accordingly, when a data value is specified (i.e. “set”) for a controller 204 at a particular step or sub-step and that value is pushed to a controller 204 via the one or more software applications 306, the value adjusts what the underlying controller 204 considers to be a healthy or unhealthy state in its related I/O devices 202 (e.g., valve I/O device 202a open or closed; fluid input valve I/O device 202b open or closed; pump I/O device 202c on at a set speed or off, etc.). In other words, by inputting values into the file set that are controller 204- and step-specific, a user can adjust setpoints (i.e. acceptable parameters) in the associated controller 204 and control operation of the associated I/O devices 202 with a high degree of specificity.

Likewise, feedback data received from each controller 204 during operation (e.g., as reflected in the controller 204-specific folders in the database 304) can be compared against these setpoints and used by the system 300 to determine if a particular I/O device 202 (or group thereof) are in a healthy or unhealthy state. Similarly, handshakes between the software applications 306 and the controllers 204, and between the database 304 and the software applications 306, can provide real-time run status. In this manner, errors in the industrial automation system can be easily identified and diagnosed.

A user may configure any number of system programs/configurations in the database 304 simply by creating a table for each, linking each step/sequence (or sub-step) of the configuration to the appropriate controller(s) 204 and I/O devices 202 (via the file set), and creating a dataset of setpoints, parameters, conditions, sequence flows, and other variable values for each sequence with respect to each controller 204 and/or I/O device 202, as appropriate (with each value representing the desired function of such I/O device 202 at a particular step or sub-step).

In practical application, any number of values can be associated with a particular configuration and, in at least one embodiment, a configuration may define or set at or between 7,000-10,000 (or more) values. Further, changes of that many or more values can be pushed to, and saved and read by, the controllers 204 using the system 300 hereof in less than a minute. Due to the large scale of values that can be utilized and pushed to the controllers 204, hard-coded controller 204 programs need not be modified at the controller 204-level as with conventional systems, but instead are leveraged through modification of values (i.e. turning I/O device 202 variants on and off, changing set points, etc.) that can alter controller 204 functional outcome and ultimately mimic wide-sweeping controller program changes. Further, these variants can be employed in such a manner across the plurality of controllers 204 to implement state, step, and/or other logics as desired.

The tables, folders and datafiles in the database 304 can be configured upon set up of the system 300 or at any time thereafter, as desired (e.g., via execution of the file service 306a, the data service 306b and/or the configuration application 306c as defined below).

The system 300 also has one or more software 306 components executable by the server 302. The software 306 instructions are stored in a standard memory unit such as a random access memory (RAM) and/or in a mass storage unit such as a hard disk drive or external database, which can be physically connected to the server 302 or located remotely and accessible by the server 302. Indeed, the system 300 architecture does not require a static topology and is instead flexible.

The one or more software applications 306 comprise at least a file service 306a, a data service 306b, and a configuration application 306c. In at least one embodiment, the one or more software applications 306 additionally comprise an output service 306d.

In at least one exemplary embodiment, the one or more software applications 306 comprise at least one application that utilizes an Acquire/Release methodology to allow sequencers to own other sequencers and thus produce a uniform logic at all stages within the production process. This logic can then be represented as an array to each I/O device 202 of the system 300.

The configuration application 306c facilitates set up and implementation of a system program and, in particular, one or more configurations. In at least one embodiment, the configuration application 306c can comprise the “front end” through which a user can interact with and configure the available system configurations. At set up, multiple configuration folders/tables can be created through entry via the configuration application 306a of the sequences of steps and sub-steps, setpoint values, boundaries, and parameters for each controller 204 mapped to the system 300 for that particular configuration. In at least one embodiment, value data is entered for each defined step (and sub-step) of each configuration and, if one or more controllers 204 and/or I/O devices 202 are not required for one or more steps or sub-steps, data indicative of non-use is input for those controllers 204 at the appropriate steps/sub-steps. Any number of configurations may be entered and, when saved in the database 304, are available to a user for execution as desired.

The file service 306a is configured to interact with the database 304 and create and populate datafiles that relate to the configuration data stored in the tables or folders (i.e. an active file) when a specific configuration is selected. The file service 306a can run on the server 302 or any other processor with access to at least those portions of the database 304 that stores the configuration tables/folders (and, optionally, the controller 204-specific folders) and is configured to create and populate the active file set when a configuration is selected for execution. The active file set can be stored in any one of the databases 304 or even remote of the system 300. In at least one embodiment, the file service 306a creates such active file sets in a file structure that corresponds with the file structure of the controller 204-specific folders. For example, if a system 300 has configurations 1, 2, and 3 available (i.e. stored within the database 304), and a user selects to run configuration 2, the file service 306a is configured to access the folder or table within the database 304 associated with configuration 2 and create and populate a separate active file set based on the data stored therein.

In operation, the file service 306a is in communication with at least one of the one or more databases 304. After an active file set is created and populated, the file service 306a can be configured to repeatedly query the active file set (via handshakes or otherwise) and related configuration folders/table to ensure both align (i.e. no change has been made). For example, if there are no new changes in the database 304, the file service 306a just sits and performs a heartbeat with the database 304 to ensure it is running and online as appropriate. If a change is identified in the configuration folder/table (via placement of a flag or otherwise, the file service 306a can delete the active file set and automatically re-create and re-populate an updated active file set that properly aligns with the configuration data.

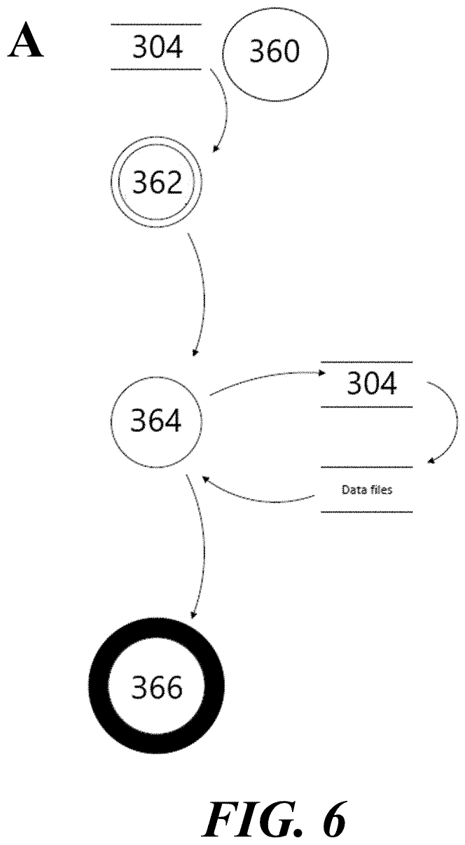

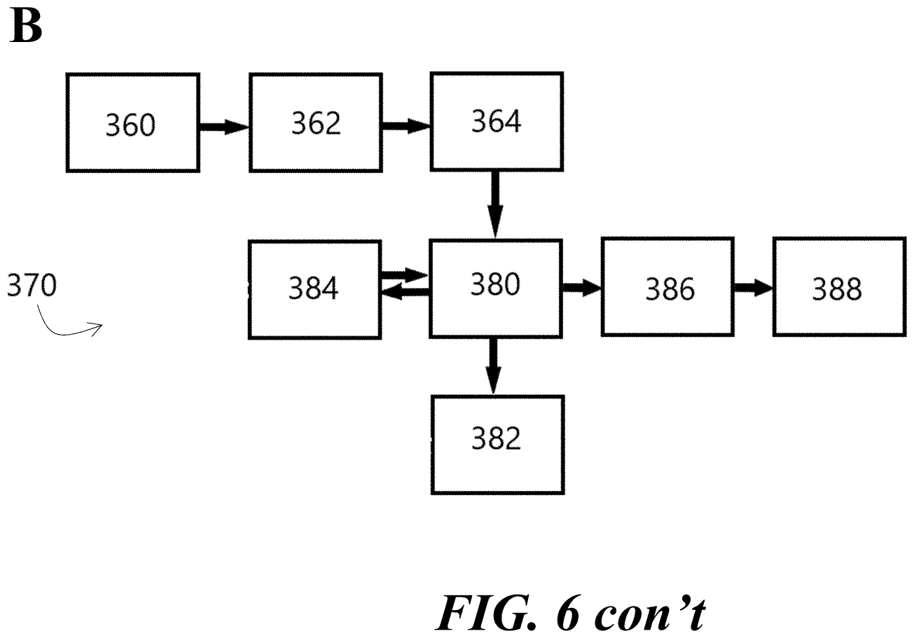

FIG. 6, subpart A shows a flow chart representative of at least one method through which a configuration can be selected and implemented by the sequencing system 300. The file service 306a periodically queries the table within the database 304 related to the then-active configuration to identify if any value changes have been made. If a user selects a different configuration to run or otherwise modifies a parameters (e.g., such as batch size), at step 360, a flag is set in the database 304 to mark the value update or change. It will be appreciated that flags (or the like) can be used to mark any change, deletion, or other modification of a configuration dataset within the database 304 pursuant to techniques known in the art.

At step 362, the file service 306a identifies the update or change and deletes all files and folders that correspond with the previous active file set of the previous configuration (if applicable).

At step 364, the file service 306a queries the database 304 for the updated values (i.e. the now-selected configuration) and recreates new files and folders as required for the now-selected active file set. When the value count and the update count are equal, the update is complete (step 366) and the file service 306a removes the flag from the database 304 that indicates the change.

Deletion of the previous active file set from the folder structure and recreation thereof ensures that no orphaned data remains. For example, in at least one embodiment, where a parameter is deleted from a sequence contained in ConfigurationX that gets passed to a step, the file service 306a identifies this change and deletes all files associated with Configuration X in their entirety, and recreates the same with the changed values, while other unmodified, running configurations (e.g., A, B, C, . . . ) are left intact. In other words, where there are more than one active file sets at any given time, but only one is changed, in at least one embodiment, the file service 306a will only delete and repopulate the active file set associated with the identified change; all others can remain running and intact.

In yet another non-limiting example, if a first configuration (configuration 1) is copied and named “configuration 2,” a flag is set by the configuration application 306c and the file service 306a is activated at step 360. The file service 306a will see no folders associated with configuration 2 as such configuration did not previously exist. Accordingly, the file service 306a need not delete any existing files/folders (as there are none), but creates the current active file set (in accordance with the table data associated with configuration 2) and resets the flag. If configuration 2 is later modified, the configuration application 306c sets the change flag for configuration 2, the file service 306a recognizes/sees the flag and initiates step 360 (e.g., deletes configuration 2 folder and files, recreates them with the new data, and resets the flag).

The data service 306b is, at least in part, responsible for monitoring value changes in the database 304 and, more specifically, the active file set. In at least one embodiment, the data service 306b is configured to move information from the active file set created by the file service 306a to the appropriate controller(s) 204 at the appropriate time pursuant to a sequence.

The data service 306b has access to the one or more controllers 204 in communication with the system 300, which can be achieved via network access or other means now known or hereinafter discovered.

As previously discussed, in an industrial automation system, controllers 204 (e.g., PLCs and the like) of different types and/or manufactured by different manufacturers often have different hard coded programming structures and languages (collectively, “protocols”). To address this, the data service 306b comprises a set of drivers 350, each driver configured to bidirectionally communicate with one or more controllers 204 in communication with the server 302 that have the same protocol (“a set of controllers 204”). In other words, each driver is written to communicate with a particular controller protocol (upon initial set up of the system 300 or otherwise) such that the driver 350 can 1) push data received from the database 304 (e.g., the active file set) to the applicable controller(s) 204 in a format the controllers 204 can utilize, and 2) translate data received from the set of controllers 204 into the uniform datafile format that correlates with and is storable by the set schema of the database 304.

For example, if a system 300 is in communication with one or more controllers/PLCs 204 manufactured by Siemens AG (a “first set of controllers”) that all operate using the same hard coded PLC logic (i.e. the “first protocol”), at least one driver 350a of the data service 306b (the “first driver”) is configured to interpret the first protocol into data that correlates with and is storable by the schema of the database 304. In operation, such driver 350a will translate data received from its first set of controllers into a uniform datafile structure of the database 304 and push such data to the specific folders associated with each controller 204 of the first set.

Additionally, the data service 306b is configured to periodically query the one or more databases 304 (via a handshake as described below, or otherwise) to identify if any controller 204 values have been updated in the active file set (e.g., if a user selects a configuration different from the one previously loaded/running). If the data service 306b identifies one or more value changes (as compared to the values previously set), the data service 306b will receive updated values from the database 304 and push or otherwise communicate such updated values to the appropriate controller(s) 204.

In operation, the data service 306b utilizes the driver(s) 350 to communicate with the applicable controller(s) 204 (i.e. those associated with the I/O devices 202 affected by the value updates) to clear the relevant values and push the new ones, or the data service 306b can be configured to clear all controller 204 values in the plurality of controllers 204 in communication with the system 300 and thereafter, using the drivers 350, write the values to be updated to each controller 240 such that each controller 240 runs its controller hard coded program(s) using the same. In at least one embodiment, only the data present in an active file set for the selected configuration will be updated by the data service 306b.

Additionally, in at least one embodiment, the data service 306b can, on an interval, update a running count of the number of values updated to determine if the process is complete. When the value count and the update count are equal, the configuration update is complete and the system program can be executed.

By way of a non-limiting example, FIG. 6, subpart B shows a flow chart of a method 370 for switching an automated production system from a first configuration to a second configuration. It will be appreciated that steps of this method 370 can overlap and/or be performed concurrently with the steps 360, 362, 364, and/or 366 described herein.

In at least one embodiment, at step 360, a user or operator switches the sequencing system 300 from running configuration 1 (currently running) to configuration 2 by, for example, selecting configuration 2 from the tables of the database 304.

At step 362, the file service 306a is activated and deletes all files and folders in the active file set associated with configuration 1 and, at step 364, creates and populates all folders in the new active file set related to configuration 2 with the values from configuration 2.

At step 380, the file service 306a sends, and the data service 306b receives, data from the new active file set and the data service 306b translates (using the drivers 350) the updated values into the appropriate controller-specific protocols. At step 382, the data service 306b pushes the translated values to each of the affected controllers 204 in a format that is readable by each controller 204. In this manner, the data service 306b accesses and reads the configuration values stored within the database 304 that are related to the first set of controllers 204 at a particular sequence step, for example, and pushes the updated values to each controller 204 relevant to that configuration in a manner that is understandable by each controller 204 (i.e. that corresponds with the protocol thereof). Such controllers 204 can then run their hard coded programs using the updated values, which results in implementation of configuration 2.

Step 380 can be bidirectional in that the data service 306b, by way of the drivers 350, can query, at step 384, each controller 204 in communication with the system 300 (e.g., at intervals) and receive data therefrom. The data service 306b is configured to convert the data received from the controller 204 to a format that is easily understood by other components of the system 300 (i.e. a uniform datafile format). Accordingly, at step 380, the appropriate driver 350 can also convert such received controller data values into the uniform datafile format that correlates with the structure of and is storable by the database 304.

In at least one embodiment, the data received from the controller 204 is representative of a current status of the controller 204 and/or its associated I/O devices 202. Accordingly, real-time status data regarding each I/O device 202 and the controllers 204 can flow the other direction as well (i.e. from the controller 204 to the database 304, in addition to from the database 304 to the controller 204). Alternatively, if specific values in a configuration are updated during run-time (e.g., a user modifies one or more values at a controller 204 level for particular sequence steps or a controller 204 receives data from a I/O device 202 that indicates a change is required), the data service 306b can receive such updated data, translate it into the uniform datafile format, and push it to the relevant controllers 204 for execution.

At step 386, the data service 306b transmits the translated controller values to the database 304, which updates the corresponding controller-specific folders therein at step 388. Accordingly, if an issue is identified with a particular sequence step via the data received at step 386, the system 300 can precisely flag the issue and its location, and even modify the execution of sequences through the configuration to account for the contingency.

By leveraging the drivers 350, data service 306b allows for comprehensive and real-time bidirectional communication with all brands and platforms of controllers 204 and, thus, drives the production process and/or enables users to easily modify which system programs are run from a single, centralized location. Furthermore, the data service 306b has full functionality to interact with all brands and platforms of controllers 204.

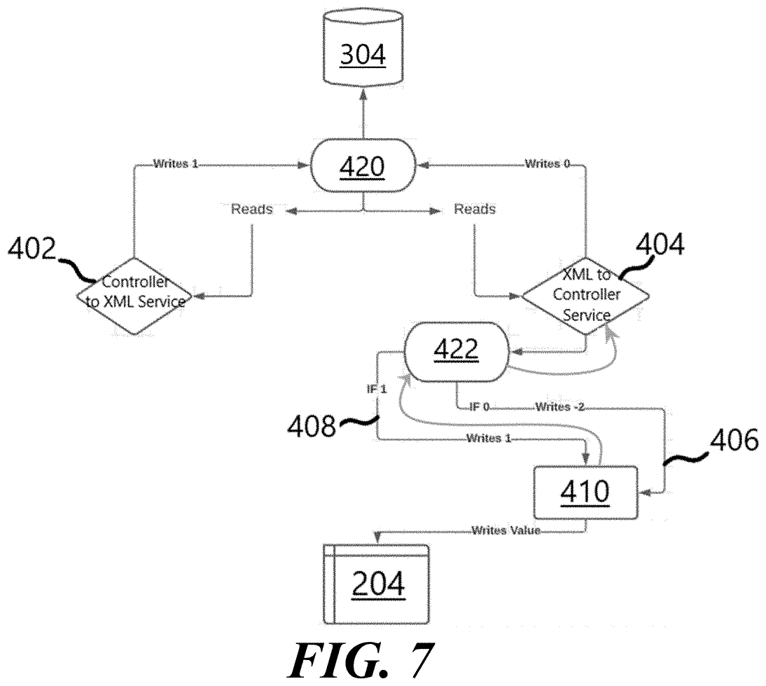

Now referring to FIG. 7, a diagram of data flows and interactions between the various components of the sequencing system 300 and a controller 204 is shown according to at least one embodiment. In operation, the file service 306a is configured to query the database 304 to identify any value updates or changes within the active file set (e.g., at an interval via a heartbeat query, etc.). The data service 306b also can repeatedly query or otherwise connect with the database 304 to identify if any values have been updated in the active file set related to the selected configuration. Such repeated queries of the database 304 can thus create communication between the file service 306a and the data service 306b (each a “handshake”) and promote activation and/or synchronization of system function. In at least one embodiment, this handshake can occur every second, however, any interval may be employed.

As used herein, and in accordance with knowledge in the art, handshaking or a heartbeat query is a type of protocol that controls data transmission between two systems or devices and, at least initially, is a signal exchange between two applications or devices to establish a communication link. Handshaking can be between two applications or systems or more (such as, for example, a three-way handshake). Here, for example, a three-way handshake can be used between the file service 306a, the data service 306b and the database 304. In at least one embodiment, a heartbeat or handshake may be a periodic signal generated by hardware or software to indicate that it is still running (e.g., the handshake described herein between the controller 204 and the data service 306b). These periodic check-in signals can also be employed for activation and/or synchronization purposes (e.g., the handshake described herein between the controller 204 and the data service 306b, but where a change in the controller 204 data is indicated, or a handshake between the file service 306a and the database 304 where a change is indicated).

As represented in FIG. 7, at step 402, the file service 306a queries the database 304 (e.g., the designated configuration folders/tables) to identify any value changes therein (e.g., if a new configuration has been selected) and, if there are none as compared to the last loaded configuration(s) (i.e. no flags are identified), the file service 306a writes a specific value indicative of no changes (e.g. “1”) at the first handshake 420. At step 404, the data service 306b reads the first handshake value and, if that value indicates no change, the data service 306b writes a value in the first handshake indicative that the data service 306b is online and reads no change (e.g., “0”). Steps 402 and 404 can each be continuously repeated, for example, every second. In at least one embodiment, steps 402 and 404 are repeated at intervals until a value change in the file set is identified.

A timer can be utilized at one or more of the steps (e.g., at steps 402 and/or 404). In at least one embodiment, the data and/or file services 306b, 306a automatically start a timer for a defined interval (e.g., 10 seconds), and steps 402 and/or 404 is/are repeated thereafter to again perform the first handshake 420 via the database 304.

Concurrently, at step 404, the data service 306b/application drivers 350 are also in communication with (e.g., repeatedly querying) the controller(s) 204 for which they are configured and perform a second handshake 422 therewith (either via a tag 410 as shown in FIG. 7 or as is otherwise known in the art). In at least one embodiment, if at step 404 the first handshake value continues to indicate no value change in the database 304 (e.g., “1”), the driver 350 writes a value at step 406 in a tag 410 of the associated controllers 204 that indicates no value change and to continue running with the values/configurations previously provided by the driver 350 (e.g. “−2”).

However, if at step 404 the data service 306b reads a value indicating a value change in the relevant file set (e.g., a “1”), the data service 306b communicates with the file service 306a to receive the updated value(s) from the relevant folders of the file set, which are turned into a call list for each tag 410 as appropriate to transfer the new value(s) to the relevant controller(s) 204 (i.e. thereby updating the controller program/sequences by way of value modifications). Accordingly, the one or more software applications 304 can repeatedly read user input into the database 304 (e.g., if a user desires to change which system program is running such as switching from the running configuration to a different configuration), and implement a new configuration in real-time.

Similarly, as indicated in connection with steps 380, 384, 386, and 388 of method 370, each controller 204 can similarly provide value data (regarding its status and/or the status of each I/O device 202 in communication therewith) to the data service 306b at the second handshake 422. Such data values can then be translated into the uniform datafile format by the designated driver(s) 350 and pushed to the database 304 as previously described in connection with method 370. In this manner, the one or more software applications 306 can provide real-time I/O device 202 and controller 204 data back to the database 304 for supervisory and maintenance purposes.

Additionally, if a local change is made at the controller 204 level, such changes or feedback can also be transmitted to the database 304 via the system 300. For example, if a user makes a run-time change at the controller 204 level or, for example, one or more controllers 204 receive input that modifies their hardcoded programming or otherwise indicates to switch configurations or not perform pursuant to the active parameter step of the configuration (e.g., a value or gate is moved with a proximity sensor or a switch is activated), such feedback can be indicated in tag 410, translated by the data service 306b and pushed to the portion of the database 304 that corresponds with the relevant controller 204 and/or configuration. Where a run-time configuration switch is made at the controller level, for example, the data service 306b can transmit such updated data to the database 304 (step 360), which flags the change(s) therein and initiates steps 362, 364, etc. of method 370. If, however, a change is made at the controller level that does not correlate with the configuration or other values saved within the database 304 (e.g., the controller feedback instructs configuration 5 should be run, but the database 304 does not contain a configuration 5 table or folder), the system 300 will indicate an error and identify the precise location and nature thereof (i.e. the controller 204, etc.).

A user can interact with the system 300 via an input device (not shown), such as a mouse, a keyboard, a switch or other such device that is in communication with the server 302. One more user interface layers can also be run on or by the server 304 (or otherwise) as is known in the art, to interface the system 300 with the input device and any output device or system 308 where appropriate. Examples of several user interface screenshots are included herein; however, it will be appreciated that any user interface design may be employed in connection with the sequencing system 300 and no limitation is intended thereby.

The output device or system 308 of the system 300 can comprise a display, such as, for example, a cathode-ray tube (CRT), a liquid crystal (LCD), a liquid emitting diode (LED), an organic light emitting diode (OLED), an active-matrix organic light-emitting diode (AMOLED), a plasma, or any other monitor or display now known or hereinafter developed, configured to display text and/or graphics, under the control of the server/CPU 304 or another processor. In at least one exemplary embodiment described below, the output device or system 308 is an HMI that facilities user interaction with the system 300. Additionally or alternatively, the output device or system 308 can be a SCADA system, under the control of the SCADA control system 206 as previously described.

Utilizing an output device or system 308 for display purposes, the sequencing system 300 can create a real-time visualization of a list of sequences, subsequences or control modules, and even the related child's list through execution of the output service 306d. Indeed, the system 300 can provide a consistent, continual visibility to each controller's 204 actual code (and value sets) running in such controller 204. In this manner, the sequencing system 300 enables provision of a unified view of data despite such data residing in disparate locations (i.e. controllers 204 located in different plants and/or different geographical locations).

The output service 306d is configured to interact with the database 304 and one or more user interface layers to display controller 204 data values and other data relative to the industrial processing system. In at least one embodiment, the output service 306d supports various output formats and output design features as is known in the art.

Where reporting functionality is desired, the output service 306d can comprise a reporting module 750 configured to generate reports in accordance with user-input criteria and a report server. In at least one embodiment, the reporting module 750 is configured to automatically generate reports on the sequence hierarchy, steps, alarms, and parameters of the active file set.

In at least one embodiment, the reporting module 750 comprises a server or a database (e.g., a SQL server database) that stores, at least in part, configuration structures, report definitions, report metadata, report history, cache policy, snapshots, resources, security settings, encrypted data, scheduling and delivery data, and extension information. The report server can be the same server as server 302 or, alternatively, may be separate therefrom. In at least one embodiment where the report server is a standalone report management solution, the report server can be web-based and accessible by the output device or system 308. In another embodiment, the report server can be a third-party component or otherwise independent component integrated or in communication with the output device or system 308 or the server 302 (for example, and without limitation, a software-as-a-service application that is hosted or cloud based). One of ordinary skill in the art will appreciate that the reporting functionality described herein may be incorporated into the present system 300 in various different ways and the examples provided herein are not limiting.

In at least one exemplary embodiment, the reporting module 750 is configured to automatically generate updated documentation each time a change is made in a system program (e.g., a configuration change). There, when the file service 306a identifies a change, the reporting module 750 is initiated to generate the documentation. Alternatively, the reporting module 750 can be configured itself to monitor flags within the database 304 (e.g., on the configuration folders/tables stored therein). As documentation is often required for regulatory and other purposes in connection with industrial automation systems, the present system 300 allows for the reporting module 750 to easily access, read, and generate reports from the relevant (and real-time) data stored in the database 304 because such data is stored in the uniform file format. This significantly streamlines conventional processes that require technicians to manually identify and manually document each change every time a configuration is modified or switched out.

A user can customize a desired report structure and the specific data to display, and the reporting module 750 can pull such data from the database 304 (either by recruiting the file service 306a or directly as per above). In at least one embodiment, the report server, reporting module 750, and/or the output device or system 308) may be in communication or interfaced with a communication service (e.g., email) such that a copy of a generated report can be electronically mailed or otherwise sent to a desired recipient via a network.

Additionally, the reporting module 750 can generate print documents in various formats by populating template files with data from the database 304 (which is stored in the uniform file format, e.g., XML data). Where the output device or system 308 is a SCADA system, a separate report server need not be required; instead, the system 300 can leverage the standard SCADA report and/or trend functionality in connection with the database 304 to provide, for example, a batch or other desired report.

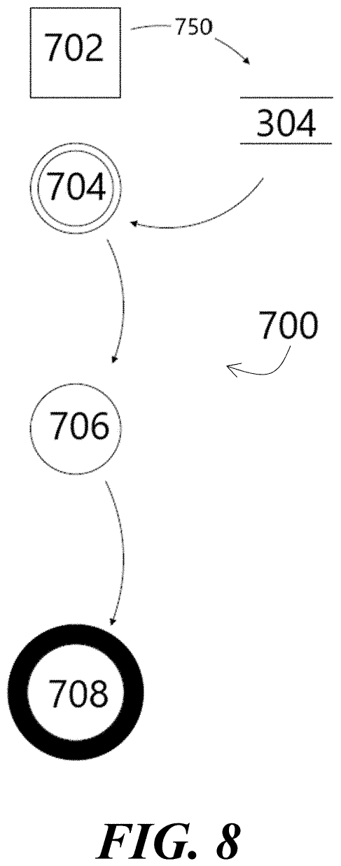

FIG. 8 shows a flow chart representative of a method for generating a report using the sequencing system 300 comprising a reporting module 750. At step 702, the reporting module 750 receives a signal to create a report. This signal can comprise a user indicating to the reporting module 750 to generate a report (and, for example, one or more specific configurations for which a report is to be generated) or the reporting module 750 can be configured to perform periodic handshakes with the database 304 to identify any changes in running configurations and, if identified, automatically generate a report. Communication between the reporting module 750 and the database 304 can be direct (e.g., where the report server coincides with the server 302), over a network such as the Internet (e.g., via the output device or system 308) or through any other communication modality.

In certain embodiments, the user can also select the desired values to be included in the report and/or the desired format and design features thereof. This can be done at set up or, where a user indicates to the reporting module 750 to prepare a specific, one-off report, at the time of ordering/signaling creation of the report.

When a signal is received by the reporting module 750 to generate a report at step 702, the reporting module 750 queries the database 304 for the configuration information at issue and receives copies of the requested data at step 704. Using the received data, the reporting module 750 builds, at step 706, a representation of the selected configuration (e.g., a graphical or schematic representation). In at least one embodiment, the report can include a Sequence hierarchy, control points, parameters, and step actions. At step 708, the report is created, and a user can select to print, save, e-mail or otherwise process the report as desired.

A user can use the output device or system 308 to view the system as a whole, or opt to toggle between different controller 204 code as desired. Thus, not only can a user easily validate operation of independent components of the system remotely, additional and specialized programming at the component level is not required as the user can modify such code using the sequencing system 300.

In at least one embodiment, the server/CPU 304 of the sequencing system 300 may further comprise a secondary program that, when executed on the server 304, converts the controller 204 code into representative graphical icons such that a user can view an easy-to-understand, real-time representation of the entire system via the output device or system 308 display that is integral to or in communication with the server 304.

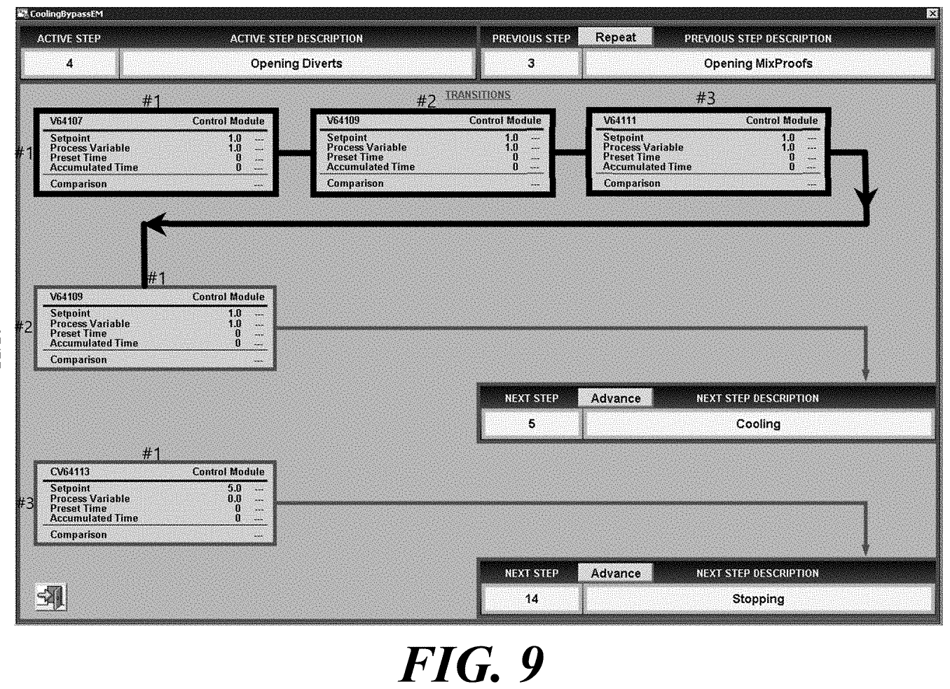

FIG. 9 shows a screenshot of at least one embodiment of a user interface displaying a graphical representation of real-time operating data from the various controllers 204 of the industrial automation system and current system program data (e.g., a step logic), such graphics created by and the data populated and maintained by the sequencing system 300 (e.g., output service 306d). The system program shown in FIG. 9 has been in and completed step #3 (“Opening Mixproofs”), is currently operating controller V64109 at step #4 (“Opening Diverts”) and has conditions to either move to step #5 (“Cooling”) or Step #14 (“Stopping”). The data displayed in such a graphical representation populated by the system 300 is dynamic and can update both the output device or system 308 and the controller 204 descriptions in real-time as operating data is received in the database 304 from the controllers 204 or configuration value change information is saved in the database 304.

In certain embodiments, the output device or system 308 is a control system 206 of a conventional SCADA system that executes a SCADA software package. There, the control system 206 is in communication with the server 302 and, via the server 302 or otherwise, has access to the database 304. As shown in FIG. 9, the graphical representations of the configurations run using the interfacing sequencing system 300 can be displayed and supported in a SCADA environment. However, one skilled in the art will recognize that other implementations are possible. For example, the present software 306 and/or at least one database 304 of the system 300 can be implemented in an embedded system within the central control system 206 or otherwise. Notwithstanding the foregoing, in at least one exemplary embodiment, the sequencing system 300 server 302 and database 304 are report from the central control system 206.

Due to the uniform datafile format leveraged by the sequencing system 300, the SCADA control system 206 can readily read and understand the data in the database 304 and, thus, has access to real-time controller 204 and I/O device 202 data. Further, a system program and/or configuration changes can be implemented from a single, centralized location using the SCADA control system 206 through leveraging the functionality of the sequencing system 300.

Primarily, the SCADA control system 206 has access to all of the configurations loaded into the database 304 (e.g., each in a table or designated folder set). In at least one embodiment, a user can select the desired configuration using the control system 206, causing the sequencing system 300 to synchronously update both the controller 204 logics (through pushing value updates via the data service 306b) and the SCADA/HMI descriptions to provide both logic updates and context at the management level. Furthermore, leveraging the reporting and trending functionality of a SCADA system, the sequencing system 300 can provide real-time graphical, schematic, and/or other representations of the logic each controller 204 is executing in a standard format (i.e. the uniform datafile format).

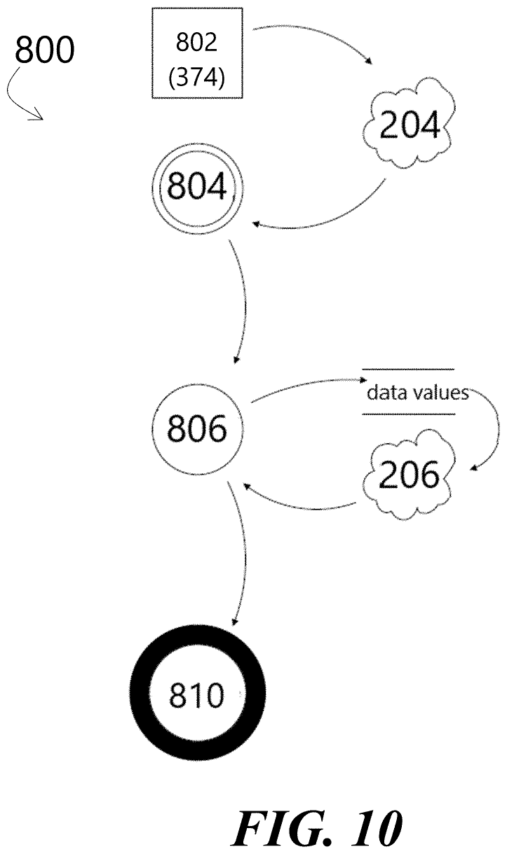

Now referring to FIG. 10, a method 800 of updating a SCADA system in communication with the sequencing system 300 hereof is shown. At step 802, a change in the database 304 is triggered by, for example, a user selecting a new configuration or modifying one or more values in a file set associated with a running configuration (i.e. a system program currently being performed by the controllers 204). Step 802 may be the same as step 374 from method 370 described above, which initiates method 370 and can initiate updated data flow to and from the controllers 204. In at least one embodiment, method 370 proceeds concurrently with method 800 and, as such, the updated values are pushed to the applicable controllers 204 and feedback values from the controllers 204 are continuously received by and updated in the database 304.

At step 804, the SCADA system becomes aware of a change to the active file set in the database 304. In at least one embodiment, this can be achieved by the output service 306d performing repeated handshakes with the SCADA system; however the output service 306d can also inform the SCADA control system 206 of file set value changes upon recognizing a value update (at step 376, for example) and need not necessarily perform handshakes with the SCADA control system 206 at any particular intervals or even at all. Alternatively, the SCADA control system 206 may have direct access to the database 304 and monitor the same directly.

At step 806, the SCADA system receives or recognizes the updated data. As the values (and other data) stored in the database 304 are in the uniform datafile format (e.g., XML), such data is recognized and readily readable by the SCADA system. Accordingly, the SCADA system updates its description values and graphical sequence depictions in accordance with the updated configuration values. In this manner, one change made in the database 304 can be propagated to both the controllers 204 and the SCADA systems (i.e. the central control system 206 thereof) without the need for any local programming changes in either location. Indeed, by leveraging the drivers 350 of the data service 306b, the sequencing system 300 has full functionality to interact with all brands and platforms of controllers 204 and the HMI component 212 of the central control system 206 and, thus, can seamlessly integrate with a SCADA system 200.

The method 800 may further comprise optional step 810, which is a verification step that is determined as complete when the value count is equivalent to the update count.

Still further, independent of or in addition to method 800, real-time measured values stored in the database 304 can be pushed to or accessed by the SCADA such that a user can visualize the real-time state of the industrial automation system and each controller 204 thereof. Such reported data can be stored and accessed in the controller 204-specific folders or in the active file set (where, for example, a controller-level change or response occurs, is pushed to the database 304 as described herein, and the active file set is updated in accordance therewith). Again, as this data is stored in the database 304 in the uniform file format that is readable by the SCADA system, such data is readily accessible and read thereby.

In this manner, all controllers 204 and I/O devices 202 can be synchronously programmed to effect changes to the system process in run time (or otherwise) and all changes can be similarly pushed to the SCADA system, which significantly reduces the likelihood of compounded programming errors and flawed functionality of the overall process system 300. Further, the need for technicians to perform ad-hoc programming at the controller level (and/or the SCADA level) is obviated. It will be appreciated that while a SCADA system is described herein, any other external system (including an ERP system, a scheduling system, or the like) may be employed.

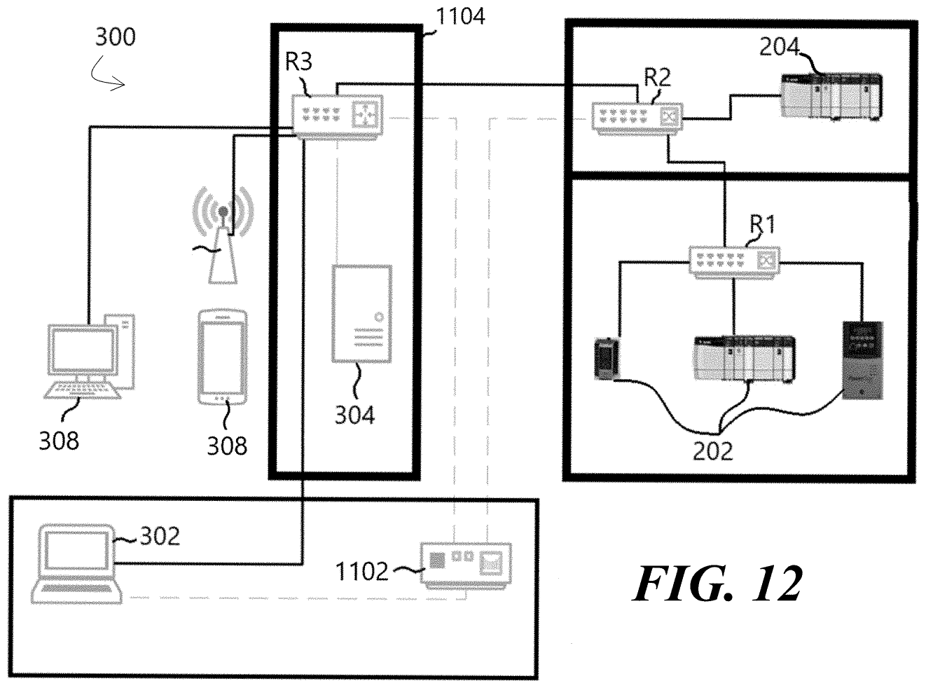

Now referring to FIGS. 11 and 12, additional embodiments of the sequencing system 300 are shown. The sequencing system 300, including the server 302, at least one database 304 and one or more software applications 306, can additionally comprise an edge device 1102. The edge device 1102 comprises any device that is suitable to translate between one type of network protocol and another (i.e. a bidirectional communications protocol). For example, and without limitation, the edge device 1102 can comprise a server for web interface, a router, one or more routing switches, integrated access devices, multiplexers, an edge concentrator, and/or a variety of other access devices. Perhaps more specifically, the edge device 1102 can comprise a machine-to-machine (MQTT) or “Internet of Things” (IoT) broker to facilitate web interface and messaging transport, such as Eclipse Mosquitto™, a Flask extension for the MQTT protocol (e.g., to facilitate the integration of a MQTT client into the web application), or the like.

In at least one embodiment, the edge device 1102 is an intermediate processing device that mediates a connection between the server 302 and components external of the system 300 (e.g., the plurality of controllers 204 and the output device or system 308/SCADA system). In at least one embodiment, however, the edge device 1102 can facilitate communication between at least one of the databases 304 of the system 300 and the server 302 (see, e.g., FIG. 12). Further, any number of routers R1, R2, R3, . . . etc. can be employed as desired as part of an overall network structure.

In the embodiment of FIG. 11, the edge device 1102, at least one of the databases 304, and the one or more applications 306 are all on the server 302 of the system 300 which together is considered the sequencing environment 1101.

In the embodiment shown in FIG. 12, the server 302 and edge device 1102 are positioned independently of the database 302. There, at least one database 304 is positioned within an IT closet 1104 with a router R3 that is in communication (wired or wireless) with the central control system 206 of a SCADA system, the server 304 of the sequencing system 300, and the controllers 204n. Accordingly, data from both the central control system 3 206 and the controllers 204 flows through the IT closet 1104 before reaching the server 304 of the sequencing system 300.

### Examples and DataFlows

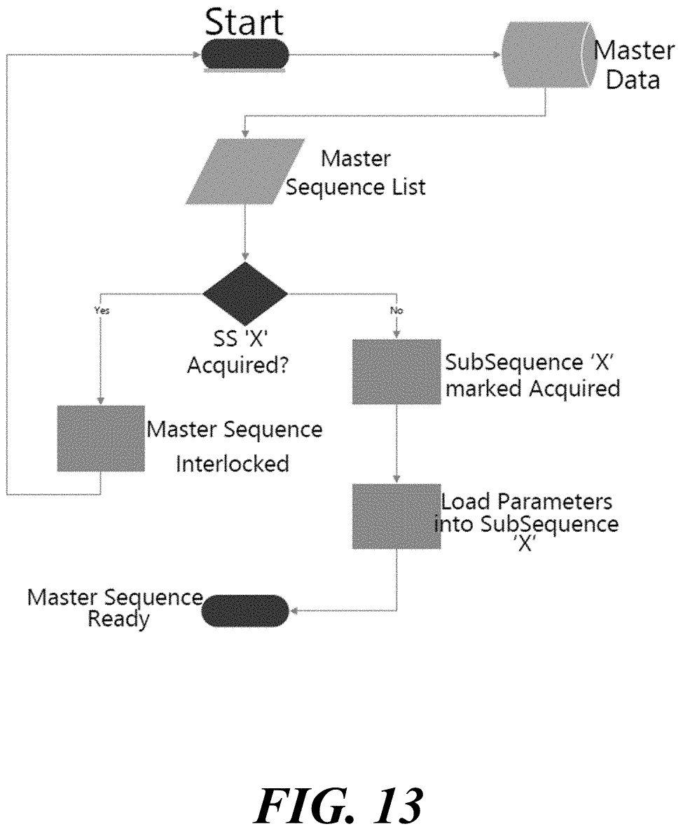

Reference is now made to FIGS. 13-19, which represent simplified flowchart illustrations of various methods of operation of the sequencing system 300 of the present disclosure. Such operational flowcharts are provided merely by way of example and are not intended to be limiting.

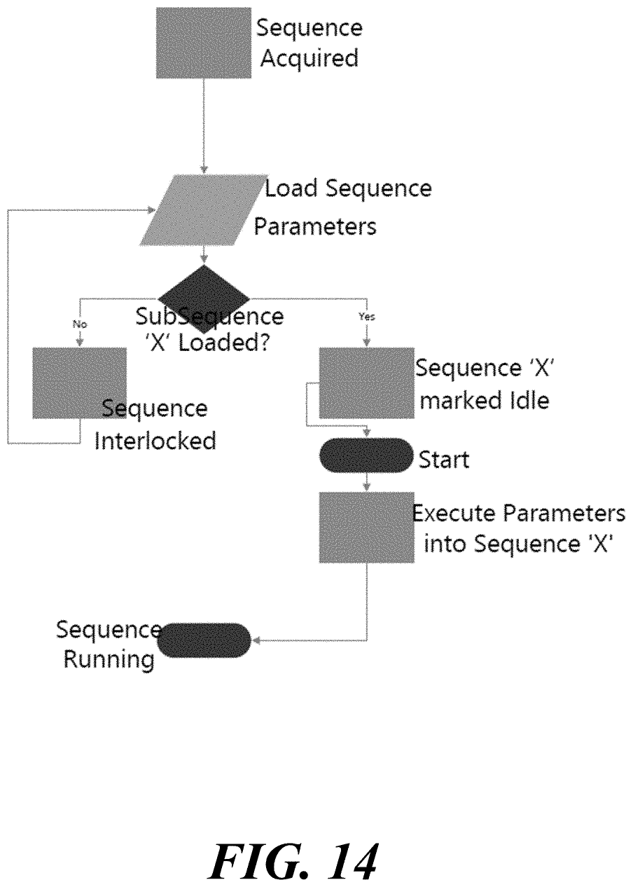

In FIGS. 13 and 14, examples of at least one dataflow related to running a sequence configuration using system 300 is shown. Here, the sequence of note comprises one or more subsequences, however, it will be understood that a sequence need not comprise a subsequence at all, in which case the process will proceed with acquisition of the sequence in a like manner as described. Primarily, such processes are carried out by the controllers 204 of the system 300 as is known in the art; indeed, the software applications 306 have already transferred the appropriate data to each controller 204 of the system 300, which stores such data and associates the loaded values with the particular step number of the sequence. Accordingly, once the desired configuration is loaded to the controllers 204 via the system 300, the system 300 itself and components thereof (other than the controllers 204) need not be running and/or in communication with the controllers 204 unless or until a user desires to perform an operation of the system 300 (e.g., check the status of the controllers 204 and/or modify the running configuration).

When a sequence is initiated (i.e. moved from “Idle” state to any other state; the “active sequence”), a controller 204 performs a lookup in the list of subsequences (SS or each a “child sequence”) associated with that active file set (i.e. the “parent sequence”) to determine their availability. Such sequences and subsequences can be stored in one or more designated locations of the one or more databases 304 in a master sequence list, for example, which can comprise one or more folders assigned to each sequence or subsequence and labeled with a particular identifier, for example (i.e. SS#1, SS#2, etc.). If the active sequence includes subsequences that are already in use by adjacent sequences (and/or other running configurations) such subsequences are already “Acquired,” and the active sequence moves into an “Interlocked” state. In “Interlocked” state, the controller 204 repeatedly queries the subsequences loaded thereon that are associated with the active file set to determine their availability. When the subsequences of the sequence are identified as available, the subsequences are then “Acquired” (as well as the sequence as a whole) and the sequence status moves back to “Idle” status, at which time it can be started. Accordingly, the value parameters for the particular subsequence(s) can then be loaded and executed by the controller 204.

As shown in FIG. 14, when a subsequence is acquired, the controller 204 can move parameters from the parent sequence to each subsequence's parameter list. This can happen as soon as acquisition occurs, if instructed in the configuration. When the subsequence moves from “Idle” to “Running” or another predefined state (e.g., per the configuration), those parameters can be used in the execution of steps by the subsequence using the controllers 204.

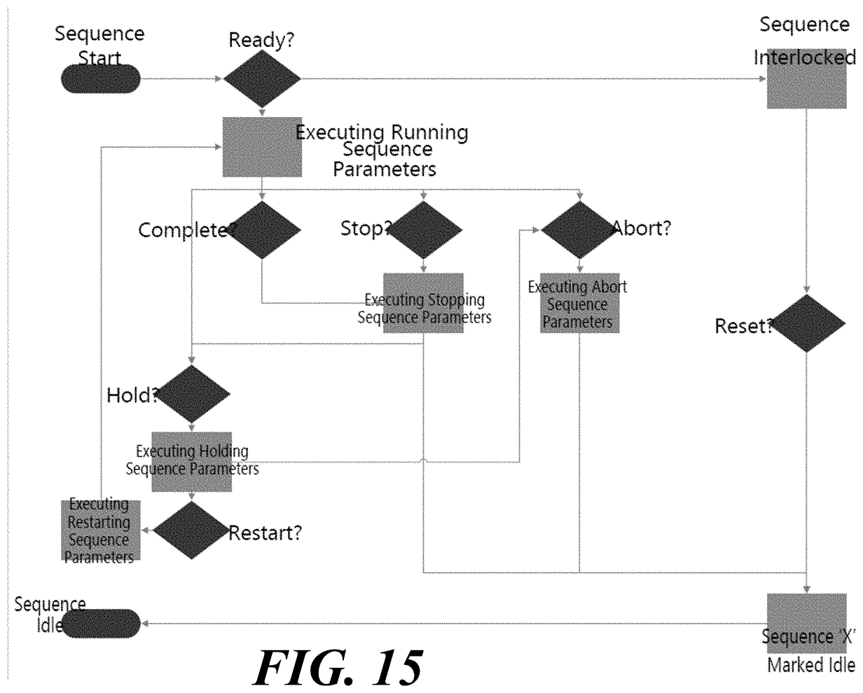

FIG. 15 displays at least one exemplary standard state model that can be utilized by the controllers 204 of system 300. It will be noted that this state model is fluid and can be changed by the user as desired; however, “Idle” and “Interlocked” states can have certain qualities that persist even where renamed by a user. In at least one embodiment, “Idle” state (e.g., 0) always releases subsequences and “Interlocked” state never allows to be reset with an Interlock active.

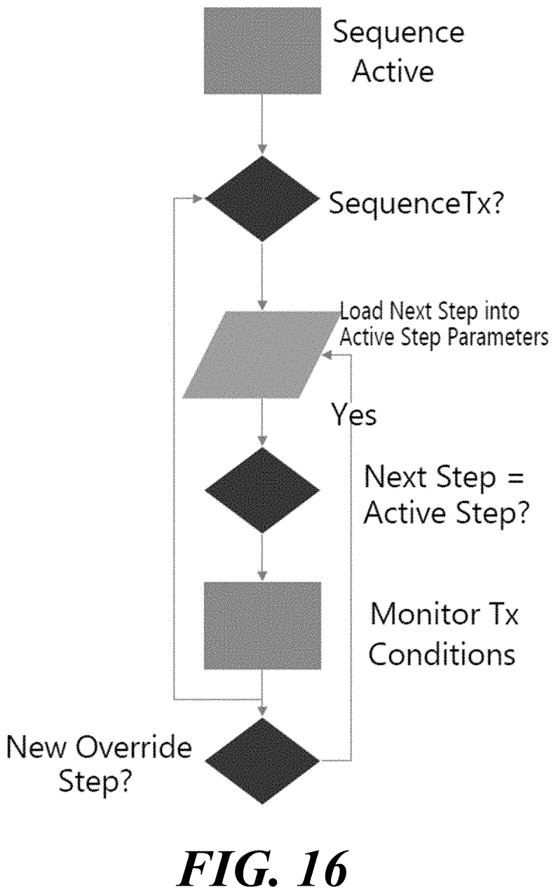

In at least one embodiment, as shown in FIG. 16, when a sequence is away from “Idle” state, whether or not the defined sequence conditions have been satisfied (SequenceTx) is periodically evaluated by the controller 204. When such conditions are met, the sequence (at each controller 204-level) advances to its next step, the sequence loads the next steps configuration into runtime (i.e. an additional step besides that which is currently executing) and the sequence state is monitored until Idle state is achieved again.

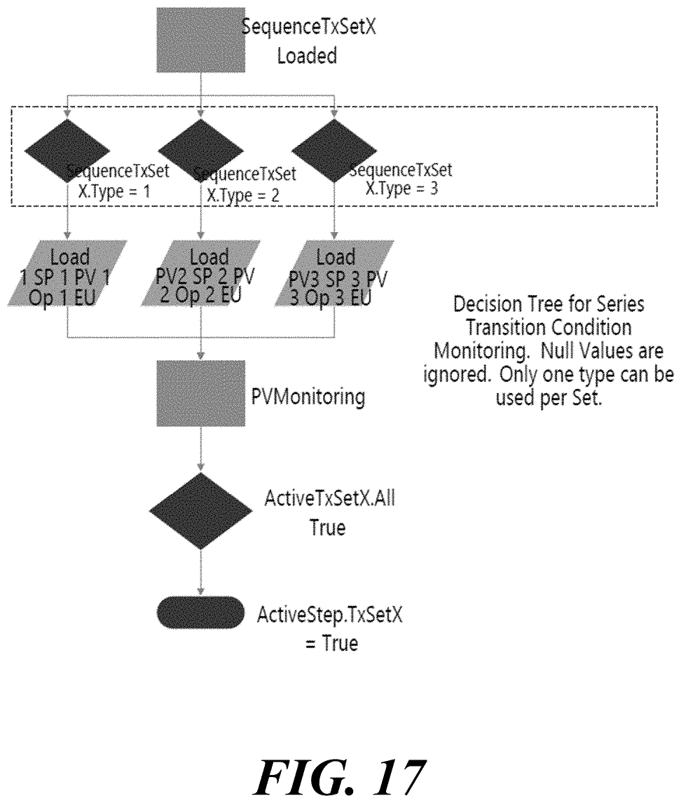

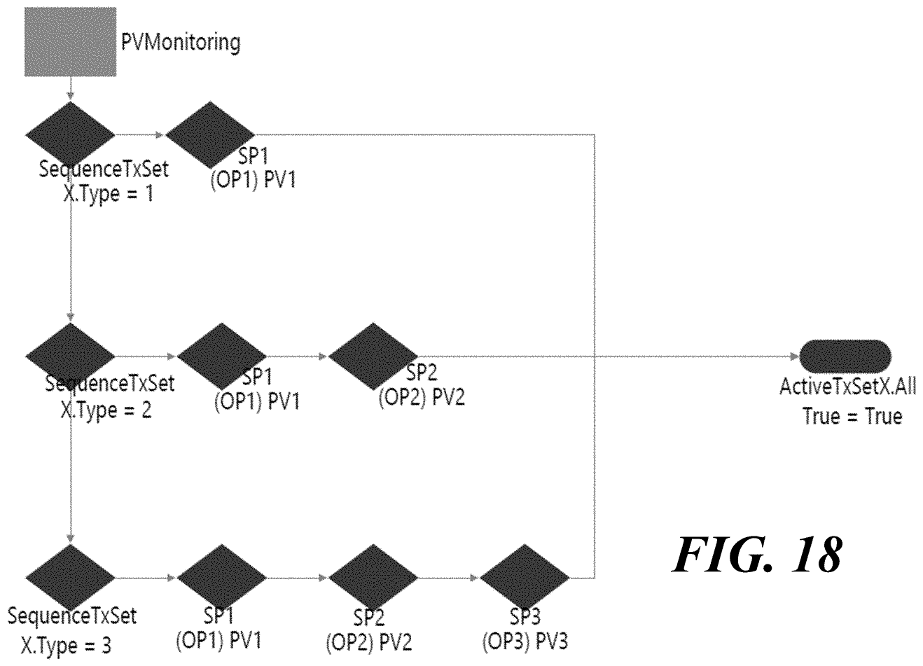

As illustrated in FIGS. 17 and 18, a sequence can have more than one available next step (here, 1, 2, and 3). For instance, if the first pass of a production batch is required to prime a pipe or container with product, time and material can be conserved by not repriming the system once it has already been done. There, for example, a prerequisite to Step 2's Next Step1 can be “not primed” (with a value of 3) and Next Step2 can be “primed” (with a value of 4). The system 300 can issue actions with no next step as well. For example, if a user desires to start up a pump and continuously wait until being told to stop, Next Step1 may be configured to have a value of −1.

Additionally, each Next Step (sub-step) of a Sequence Step can instruct a number of activities. For example, and without limitation, each step or sub-step can issue actions and wait for a response, wait for a response, wait for a defined period, or simply issue an action. FIG. 18 illustrates that multiple combinations of options are available. For instance, if the sub-step type is 1, only one activity is taking place while a type of 2 indicates 2 activities are occurring at that sub-step, etc. If all the activities of the sub-step are true, the sequence will advance to the sub-step's defined Next Step.

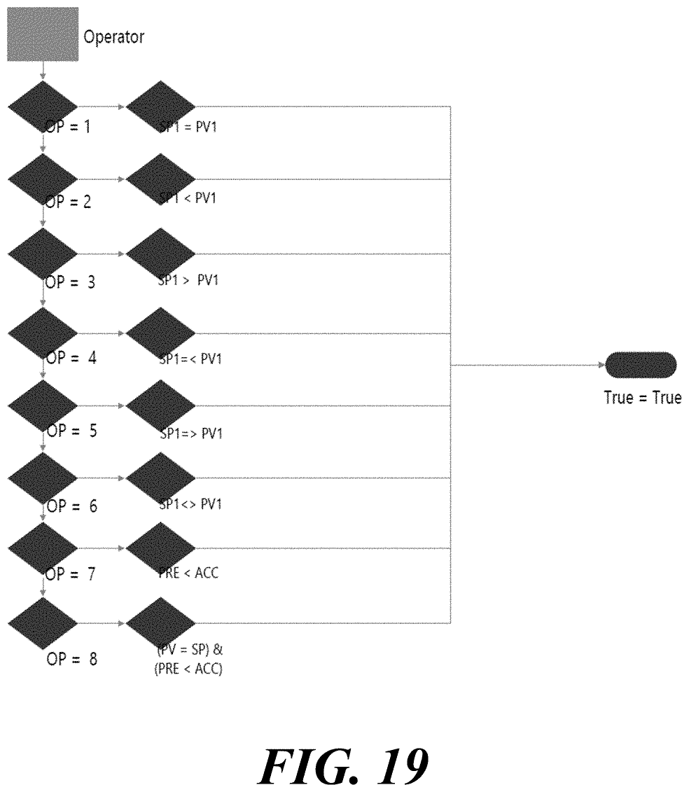

As mentioned in connection with FIG. 18, each activity of a step may be configured to achieve different goals. FIG. 19 provides a general description of some such available functions. For example, and without limitation, if the activity's Operator is defined as a Type 1 (OP=1), the controller 204 looks for the Setpoint (SP) of the activity to equal the Process Variable (SP) (i.e. the feedback data) from the setpoint being monitored (e.g., an I/O setpoint or feedback from the command (output) that was issued by the controller 204). When this is achieved, the activity is true and feed into the truth chain shown in FIG. 18. For example, and without limitation, a higher-level sequencer can start another sequencer (i.e. issue a command of ‘1” with a SP of 1). When the subsequence returns a PV of ‘1’ (i.e. “Running” or “Started”), the operator (i.e. connected controller 204) would then evaluate that substep as true.

While various embodiments of the universal sequencing systems and methods of using the same have been described in considerable detail herein, the embodiments are merely offered as non-limiting examples of the disclosure. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A sequencing system comprising:
one or more servers;
at least one database having a set schema in communication with the one or more servers; and
one or more software applications executable by the one or more servers comprising at least a file service and a data service, the file service in communication with the at least one database configured to populate an active file set based on data from a selected configuration stored in the at least one database, and the data service comprising a set of drivers, each driver configured to:
bidirectionally communicate with a set of one or more controllers that have a protocol, translate feedback data received from the set of controllers into a uniform format that correlates with and is storable within the at least one database, and
translate data from the active file set into the protocol;
wherein the selected configuration comprises a series of instructions and parameters for executing an industrial automation system program using one or more controllers.

2. The sequencing system of claim 1, further comprising a plurality of controllers, each controller:
in communication at least one input/output (I/O) device and the server, the database, or both over a network; and
having a protocol, wherein there are at least two different protocols within the plurality of controllers.

3. The sequencing system of claim 1, further comprising an output device or system in communication with the at least one database and configured to read the uniform format.

4. The system of claim 3, wherein the output device or system comprises a human machine interface (HMI) and the one or more software applications further comprise a configuration application configured to receive and store, in the at least one database, one or more configurations, each configuration comprising a series of sequences to be performed by a set of one or more controllers associated input/output devices, with each sequence associated with one or more setpoints, conditions, or values.

5. The system of claim 4, wherein the HMI is part of a supervisory control and data acquisition system (SCADA).

6. The system of claim 1, wherein the uniform format is selected from a group consisting of an XML format, a SCV format, a JSON format, a MDF format, a NDF format, and an LDF format.

7. The system of claim 1, wherein the one or more controllers are selected from a group consisting of: a programmable logic controller, a remote terminal unit, and a proportional-integral-derivative controller.

8. The system of claim 1, wherein each protocol comprises disparate high level command structures.

9. The system of claim 1, wherein the data service is configured to transmit feedback data translated into the uniform format to the at least one database.

10. The system of claim 2, wherein the at least one database further comprises:
at least one table, each table populated with a series of steps for an automation program to be performed by the I/O devices in communication with the plurality of controllers, and each step comprising one or more setpoint values for each I/O device at each step; and
at least one folder dedicated to each of the plurality of controllers, each folder comprising mapping data of the respective controller and each I/O device in communication therewith and fields for inputting the one or more setpoint values from the at least one table.

11. The system of claim 3, wherein the output device or system comprises a reporting module, the reporting module configured to generate a report based, at least in part, on the feedback data stored in the at least one database.

12. A sequencing system comprising:
one or more servers;
at least one database having a set schema in communication with the one or more servers; and
one or more software applications executable by the one or more servers that comprise at least a file service and a data service, the file service in communication with the at least one database and configured to populate an active file set based on data from a selected configuration, and the data service comprising a set of drivers, each driver configured to:
bidirectionally communicate with a set of one or more controllers that have a protocol, translate feedback data received from the set of controllers into a uniform format that correlates with and is storable within the at least one database,
transmit the translated feedback data to a first database of the at least one database, and
translate data from the active file set into the protocol,
wherein the selected configuration comprises a series of instructions and parameters for executing an industrial automation system program using one or more controller;
a supervisory control and data acquisition (SCADA) system in communication with at least the first database of the at least one database; and
a reporting module in communication with the at least one database and the SCADA system, the reporting module configured to generate a report based, at least in part, on the feedback data stored in the at least one database.

13. The sequencing system of claim 12, wherein the SCADA system is further in communication with a second database of the at least one database, wherein the selected configuration is saved in the second database.

14. A method for changing between active configurations in an industrial automation system comprising the steps of:
providing a sequencing system comprising:
one or more servers;
at least one database having a set schema in communication with the one or more servers;
one or more configurations saved in the at least one database; and
one or more software applications executable by the one or more servers that comprise at least a file service and a data service, the file service in communication with the at least one database and configured to populate an active file set based on data from a selected configuration of the one or more configurations, and the data service comprising a set of drivers, each driver configured to:
bidirectionally communicate with a set of one or more controllers that have a protocol, translate feedback data received from the set of controllers into a uniform format that correlates with and is storable within the at least one database, and
translate data from the active file set into the protocol;
wherein the one or more configurations each comprises a series of instructions and parameters for executing an industrial automation system program using one or more controllers;
executing a first configuration of the one or more configurations using a plurality of controllers in communication with the one or more servers, the first configuration associated with a first active file set of defined values stored in the at least one database;
selecting a second configuration of the one or more configurations to execute, the second configuration associated with a second active file set of defined values stored in the at least one database;
executing the second configuration using a set of targeted controllers of the plurality of controllers by:
populating, using the file service, a second active file set in the database with values associated with the second configuration,
translating, using the data service, the values of the second active file set into a protocol associated with the set of targeted controllers such that each controller of the targeted set can read the translated values, and
transmitting the translated values to each controller of the second set.

15. The method of claim 14, further comprising:
identifying a change in between the first file set and the second file set; and
deleting, using the file service, the first active file set from the at least one database.

16. The method of claim 14, further comprising notifying an output device or system of a changeover from the first configuration to the second configuration.

17. The method of claim 16, wherein notifying an output device or system of a changeover further comprises providing the output device or system access to the second file set.

18. The method of claim 14, further comprising:
receiving, using the data service, feedback data from at least a portion of the plurality of controllers;
translating, using the controller service, the feedback data into a uniform file format; and
saving the feedback data in the uniform file format in the at least one database in accordance with an organization structure that correlates the saved feedback data with each controller from which the feedback data originated.

19. The method of claim 16, wherein the output device or system is configured to interface with the at least one database and read the feedback data and data of the one or more configurations.

20. The method of claim 18, wherein the feedback data saved in the database is real-time data.
